(19) United States
(12) Patent Application Publication
(10) Pub. No.: US 2022/0143438 A1
(43) Pub. Date: May 12, 2022

(54) SYSTEMS AND METHODS FOR PREVENTING THE SPREAD OF FIRE

(71) Applicant: WILDFIRE SHIELD, Palo Alto, CA (US)

(72) Inventors: David Stanley, Palo Alto, CA (US); Doug McLean, Palo Alto, CA (US)

(21) Appl. No.: 17/519,389

(22) Filed: Nov. 4, 2021

Related U.S. Application Data
(60) Provisional application No. 63/110,885, filed on Nov. 6, 2020.

(51) Int. Cl. A62C 3/02

(52) U.S. Cl. CPC A62C 3/0214; A62C 3/0292; A62C 3/0271

(57) ABSTRACT

System and methods of protecting against the spread of fire. A method includes receiving data from at least one sensor. The method determines whether the data satisfies risk criteria for a first zone and/or a second zone of a plurality of zones of a structure. The first zone is associated with a first set of nozzles of a plurality of nozzles and the second zone is associated with a second set of nozzles of the plurality of nozzles. In accordance with a determination that the data satisfies the risk criteria for the first zone and not the second zone, the method provides first instructions to a pump to distribute a fire suppressant from a reservoir via a supply line fluidically coupled to the plurality of nozzles. The method further provides second instructions to a manifold to distribute the fire suppressant via the first set of nozzles and not the second zone.

### CROSS-REFERENCE TO RELATED APPLICATION(S)

This application claims priority to and is a non-provisional of U.S. Provisional Application Ser. No. 63/110,885, entitled “Systems And Methods For Preventing The Spread Of Fire,” filed on Nov. 6, 2020, the entirety of which is incorporated herein by reference.

### TECHNICAL FIELD

This generally relates to fire prevention systems, and, more specifically, to controlled presoaking of a structure within a fire hazard zone to prevent the spread of fire.

### BACKGROUND

Fires spread at considerable speeds, and a delayed response to a detected or approaching fire creates a high risk that a structure in the path of the fire will be damaged or completely destroyed. Conventional fire protection systems activate when a structure is on fire or a fire is detected in proximity to the structure. By the time these fire protection systems activate, it may no longer be possible to stop the fire or stop it from spreading. This results in a considerable liability to many structure owners as they are unable to take appropriate precautions in protecting their structures from surrounding fires.

### SUMMARY

A wildfire protection system as described herein can efficiently and accurately detect a fire approaching a structure and activate to prevent the structure from catching fire. A wildfire shielding system for shielding against the spread of fire to zones of a structure includes a plurality of sensors, both on the structure and remote from the structure, that obtain data for the wildfire shielding system, a reservoir that stores a fire suppressant, a pump fluidically coupled to the reservoir, a manifold fluidically coupled to the pump, one or more nozzles fluidically coupled to the manifold, and at least one controller. The controller receives data from at least one sensor of a plurality of sensors. The controller determines whether the data satisfies risk criteria for a first zone and/or a second zone of a plurality of zones of a structure. The first zone is associated with a first set of nozzles of a plurality of nozzles and the second zone is associated with a second set of nozzles of the plurality of nozzles. In accordance with a determination that the data satisfies the risk criteria for the first zone and not the second zone, the controller provides first instructions to a pump to distribute the fire suppressant from the reservoir via a supply line fluidically coupled to the plurality of nozzles. The controller further provides second instructions to a manifold to distribute the fire suppressant to the first zone and not to the second zone. Such systems and methods reduce the risk of a structure catching fire during ongoing wildfires or other fire hazard conditions. By selectively distributing fire suppressant to one or more portions of the structure at risk, such systems and methods manage the amount of fire suppressant that is used, protect a structure from catching fire, and make real-time determinations on the potential fire risk a structure faces, thus reducing the liability of the structure owners in hazardous fire conditions.

In some implementations, a method for shielding against the spread of fire includes receiving data from at least one sensor of a plurality of sensors. The method includes determining whether the data satisfies risk criteria for a first zone and/or a second zone of a plurality of zones of a structure. The first zone is associated with a first set of nozzles of a plurality of nozzles and the second zone is associated with a second set of nozzles of the plurality of nozzles. In accordance with a determination that the data satisfies the risk criteria for the first zone and not the second zone, the method includes providing first instructions to a pump to distribute a fire suppressant from a reservoir via a supply line fluidically coupled to the plurality of nozzles, and provides second instructions to a manifold to distribute the fire suppressant via the first set of nozzles to the first zone and not to the second zone. In some implementations, the first set of nozzles and the second set of nozzles are distinct. In some implementations, the fire suppressant is selected from the group consisting of: water, chemicals, gasses, and foams.

In some implementations, the method, before providing the first and second instructions, provides third instructions to a vacuum fluidically coupled to the supply line. The third instructions cause the vacuum to depressurize the supply line with a first pressure. The method includes receiving pressure data from at least one other sensor of the plurality of sensors and determines whether the pressure data satisfies a pressure criterion. In accordance with a determination that the pressure data satisfies the pressure criterion, the method includes providing the first and second instructions. In some implementations, the method includes providing the third instructions periodically. In some implementations, in accordance with a determination that the pressure data does not satisfy the pressure criterion, the method includes providing a warning notification. In some implementations, the warning notification includes an indication of zones of the structure that do not satisfy the pressure criterion. In some implementations, the warning notification includes an indication of one or more potential faults. In some implementations, the method includes providing fourth instructions to the vacuum to depressurize the supply line with a second pressure that is greater than the first pressure. The second pressure is configured to test the supply line and/or the plurality of nozzles. In some implementations, after providing the third instructions, the method includes providing fifth instructions to a compressor fluidically coupled to the supply line, wherein the fifth instructions cause the compressor to pressurize the supply line. In some implementations, the pressure from the compressor is configured to clean the supply line and/or the plurality of nozzles. In some implementations, the method includes providing sixth instructions to the pump to stop distributing the fire suppressant from the supply line.

In some implementations, the risk criteria include a fire proximity threshold, and, in determining whether the data satisfies the risk criteria for the first zone and/or the second zone, the method includes determining whether a location of a fire is at or within the fire proximity threshold. In some implementations, the risk criteria include a predetermined fire velocity, and, in determining whether the data satisfies the risk criteria for the first zone and/or the second zone, the method includes determining whether a velocity at which a fire is approaching a structure is at or greater than the predetermined fire velocity. In some implementations, the risk criteria include a predetermined dampness value, and, in determining whether the data satisfies the risk criteria for the first zone and/or the second zone, the method includes determining whether a dampness value is at or below the predetermined dampness value.

In some implementations, before a determination is made regarding whether the data satisfies the risk criteria, the method includes receiving from a remote device a command to distribute the fire suppressant, and, in response to receiving the command, providing the first and second instructions. In some implementations, before providing the first and second instructions, the method includes providing a request to a remote device to initiate distribution of the fire suppressant. Responsive to the request, the method includes receiving a command from the remote device to distribute the fire suppressant, and, in response to receiving the command, providing the first and second instructions.

In some implementations, the method includes providing the data from the at least one sensor of the plurality of sensors to a remote device. In some implementations, the data includes a first indication of a fire, wherein the first indication of the fire includes at least a location of the fire. In some implementations, the method includes receiving additional data from at least one other structure distinct from the structure. The method includes updating the data using the additional data, and determines whether the updated data satisfies the risk criteria for the first zone and/or the second zone of the structure.

In some implementations, a wildfire shielding system is configured to perform any of the methods described herein. In some implementations, the wildfire shielding system includes means for performing any of the operations described herein. In other implementations, a non-transitory computer-readable storage medium storing one or more programs is configured to perform any of the methods described herein.

In some implementations, a wildfire shielding kit for retrofitting structures includes a plurality of nozzles configured to distribute a fire suppressant at a predetermined rate; a plurality of fittings configured to connect with the plurality of nozzles and provide the fire suppressant to the plurality of nozzles; and at least one controller configured to control distribution of the fire suppressant to one or more nozzles of the plurality of nozzles. In some implementations, a number of nozzles in the plurality of nozzles is determined based on an outer area of a structure being retrofitted. In some implementations, the kit includes a first subset of nozzles of the plurality of nozzles that correspond to a first zone of the structure, and a second subset of nozzles of the plurality of nozzles that correspond to a second zone of the structure. The first and second subset of nozzles of the plurality of nozzles is determined based on the outer area of the structure being retrofitted. In some implementations, the first subset of nozzles of the plurality of nozzles are configured to be installed on the structure in a first arrangement and the second subset of nozzles of the plurality of nozzles are configured to be installed on the structure in a second arrangement. In some implementations, the plurality of nozzles include a one-way valve.

In some implementations, the kit includes a plurality of sensors configured to provide data to the at least one controller. In some implementations, a first set of sensors of the plurality of sensors is configured to provide first data to the at least one controller, wherein the first data includes measurements for a first metric, and a second set of sensors of the plurality of sensors provide second data to the at least one controller, wherein the second data includes measurements for a second metric that is different from the first metric. A metric corresponds to the type of data collected (e.g., wind data, dampness data, moisture data, and so forth) and/or a distinct location (e.g., data from sensors on a structure, data from sensors on one or more components, data from sensors remotely located from the structure, and so forth).

In some implementations, the kit includes a plurality of supply lines (e.g., pipes). Each supply line is configured to connect with a respective nozzle of the plurality of nozzles via one or more respective fittings of the plurality of fittings, and enable flow of the fire suppressant from a source to the respective nozzle. In some implementations, the kit includes a first set of supply lines of the plurality of supply lines that have a first diameter, and a second set of supply lines of the plurality of supply lines that have a second diameter.

In some implementations, the kit includes a manifold. The manifold is configured to fluidically couple to the plurality of nozzles, and distribute the fire suppressant to the one or more nozzles of the plurality of nozzles according to instructions received from the controller.

In some implementations, the kit includes a reservoir that is configured to store the fire suppressant and be fluidically coupled to the plurality of nozzles. In some implementations, the kit includes a pump configured to couple to the reservoir, and distribute the fire suppressant to one or more nozzles of the plurality of nozzles according to instructions received from the controller.

In some implementations, the kit includes a vacuum configured to be coupled to the manifold and depressurize the plurality of nozzles. In some implementations, the kit includes a compressor configured to fluidically couple to the manifold and pressurize the plurality of nozzles. In some implementations, the vacuum and the compressor are a single component.

In some implementations, the kit includes a set of instructions, wherein a first subset of instructions of the set of instructions are included on the plurality of fittings. The first subset of instructions provide directions for coupling the plurality of fittings to the plurality of nozzles via the supply lines using applied pressure, and, in accordance with the directions, removing the applied pressure.

Note that the various implementations described above can be combined with any other implementations described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not intended to circumscribe or limit the inventive subject matter.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate pertinent features of the present disclosure and are therefore not to be considered limiting, for the description may admit to other effective features.

FIG. 1 is a high-level overview of a wildfire shielding network in accordance with some implementations.

FIG. 2 is a block diagram illustrating a representative computing system in accordance with some implementations.

FIG. 3 is a block diagram illustrating a representative client device in accordance with some implementations.

FIG. 4 illustrates a wildfire shielding system implemented on a structure in accordance with some implementations.

FIGS. 5A through 5C illustrate placement of a plurality of nozzles on a structure in accordance with some implementations.

FIG. 6 illustrates a manifold of a wildfire shielding system in accordance with some implementations.

FIG. 7 illustrates a kit for installing and/or retrofitting a structure with a wildfire shielding system in accordance with some implementations.

FIG. 8 illustrates a nozzle of a plurality of nozzles in accordance with some implementations.

FIG. 9 illustrates one or more fittings in accordance with some implementations.

FIGS. 10A through 10C are flow diagrams illustrating methods of initiating a wildfire shielding system in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF IMPLEMENTATIONS

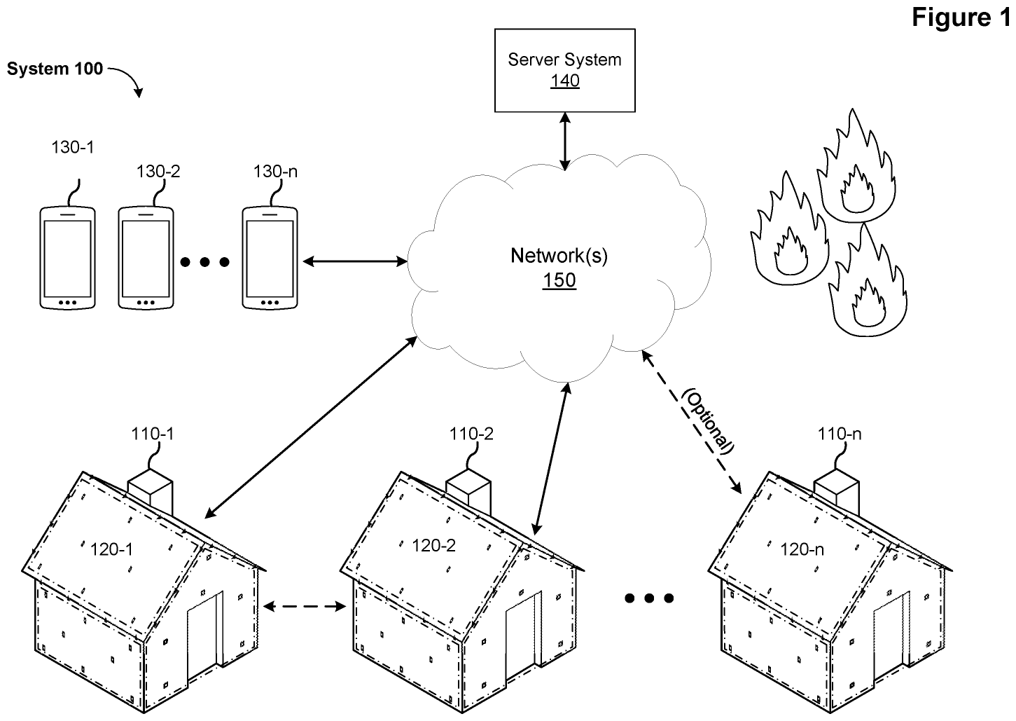

FIG. 1 illustrates an overview of a wildfire shielding system 100 in accordance with some implementations. In some implementations, the system 100 includes one or more structures 110, wildfire shielding systems 120, client devices 130, and/or a server 140 communicatively coupled via one or more networks 150. The one or more structures 110 (e.g., first structure 110-1, second structure 110-2 . . . nth structure 110-n; where n is an integer greater than 1) include a respective wildfire shielding system 120 (e.g., first wildfire shielding system 120-1, second wildfire shielding system 120-2 . . . nth wildfire shielding system 120-n). Each wildfire shielding system 120 is configured to work automatically and/or with user (e.g., owner and/or agency) input. In some implementations, the wildfire shielding systems 120 are communicatively coupled to one another via the one or more networks 150. Each wildfire shielding system 120 is configured to function independently and/or with other wildfire shielding systems 120 in a network 150. In some implementations, the one or more networks 150 include public communication networks, private communication networks, or a combination of both public and private communication networks. For example, the one or more networks 150 can be any network (or combination of networks) such as the Internet, other wide area networks (WAN), local area networks (LAN), virtual private networks (VPN), metropolitan area networks (MAN), peer-to-peer networks, ad-hoc networks, and so forth.

In some implementations, structures 110 are commonly owned by a single user or owned by a number of distinct users. For example, structures 110 may be privately owned by a single person or entity and each respective wildfire shielding system 120 is connected together via a LAN or other network 150. Alternatively or additionally, in another example, one or more of the structures 110 may be owned by distinct people and/or entities and each respective wildfire shielding system 120 of the structures is connected together via network 150. In some implementations, the one or more structures 110 are residential structures (e.g., houses, condos, apartments, mobile homes, etc.); attached structures (e.g., barns, sheds, stables, garages, farm buildings, etc.); commercial structures (e.g., retail stores, restaurants, office buildings, etc.); and/or other types of the structures. Alternatively or additionally, in some implementations, the one or more structures 110 are land and/or fields such as crops, reservations, forests, dry terrain, and/or other areas with high risk of fire. The wildfire shielding systems 120 of the structures 110 may communicatively connect to each other wirelessly and/or through a wired connection (e.g., directly through an interface, such as an Ethernet interface).

In some implementations, the wildfire shielding systems 120 of the structures 110 share (e.g., send and/or receive) data collected from respective sensors (described below) with each other through network 150. For example, first wildfire shielding system 120-1 and second wildfire shielding system 120-2 may share collected sensor data (e.g., temperature, wind speed, humidity, dampness, etc.) with each other through network 150. Additionally, in some implementations, the wildfire shielding systems 120 share respective determined risk categories (e.g., high, medium, low risk) with each other through network 150. In some implementations, the wildfire shielding systems 120 share information corresponding to initiated, failed, and/or unresponsive wildfire shielding systems 120 of the structures 110 in the network 150. For example, first wildfire shielding system 120-1 may share with second wildfire shielding system 120-2 an indication that first wildfire shielding system 120-1 was initiated or an indication that the first wildfire shielding system 120-1 failed to be initiated. Alternatively, the first wildfire shielding system 120-1 may no longer be communicating with the second wildfire shielding system 120-2. The wildfire shielding systems 120 provide information corresponding to the time of an event and/or data collection, fire suppressant reserve, current status, the number of connected wildfire shielding systems 120, maintenance and/or service information, etc.

In some implementations, the wildfire shielding systems 120 of the structure 110 are associated with one or more client devices 130 (e.g., client device 130-1 . . . client device 130-n). In some implementations, the wildfire shielding system 120 allows a respective user of a respective client device 130 to control, monitor, and/or view sensor data, risk data, and/or status data. In some implementations, the wildfire shielding systems 120 of the structures 110 are associated with a centralized organization or system via a remote device (e.g., a client device 130). In this way, the wildfire shielding systems 120 may be initiated by a centralized entity or personnel such as a fire department or a fire marshal. In some implementations, the wildfire shielding systems 120 provide associated client devices 130 warning notifications. In some implementations, the warning notifications are provided via a dedicated application, a messaging application (SMS text, internet messaging, etc.), email, a web browser, Internet of Things (IoT), etc. In some implementations, the wildfire shielding systems 120 provides the associated client devices with information corresponding to a respective wildfire shielding system 120 as discussed above. For example, the wildfire shielding systems 120 may provide an associated device 130 with information corresponding to data collected from a plurality of sensors, data collected from other wildfire shielding systems 120, and/or data and/or results derived from the collected data. In some implementations, the wildfire shielding systems 120 provides associated client device 130 requests for operating and/or maintaining the wildfire shielding systems 120. For example, first wildfire shielding system 120-1 associated with client device 130-1 may send a request to initiate the first wildfire shielding system 120-1. In some implementations, the request is sent to an agency, such as a fire department, for initiation.

In some implementations, the one or more wildfire shielding systems 120 are communicatively coupled with the server system 140. In some implementations, the one or more wildfire shielding systems 120 shares (e.g., transmits and/or receives) data with the server system 140 via the one or more communication networks 150. For example, the server system 140 may receive data (e.g., sensor data, risk data, and/or status data) from one or more wildfire shielding systems 120 and store the data, and/or share the received data with other communicatively coupled wildfire shielding systems 120. Alternatively or additionally, in some implementations, the server system 140 remotely monitors and/or controls the one or more wildfire shielding systems 120. For example, the server system 140 may receive data from the first wildfire shielding systems 120, process the received data to determine a risk category for the second wildfire shielding systems 120-2, and share the processed data with and/or control the second wildfire shielding systems 120-2.

As illustrated in FIG. 1, the wildfire shielding systems may 120 communicate directly with each other and/or other devices (e.g., client devices 130) through a wired connection and/or through a short-range wireless signal, such as those associated with personal-area-network (e.g., Wi-Fi, BLUETOOTH, and/or BLE) communication technologies, radio-frequency-based near-field communication technologies, infrared communication technologies, etc. In some implementations, the wildfire shielding systems 120 communicate with other wildfire shielding systems 120 and/or client devices 130 through network(s) 150.

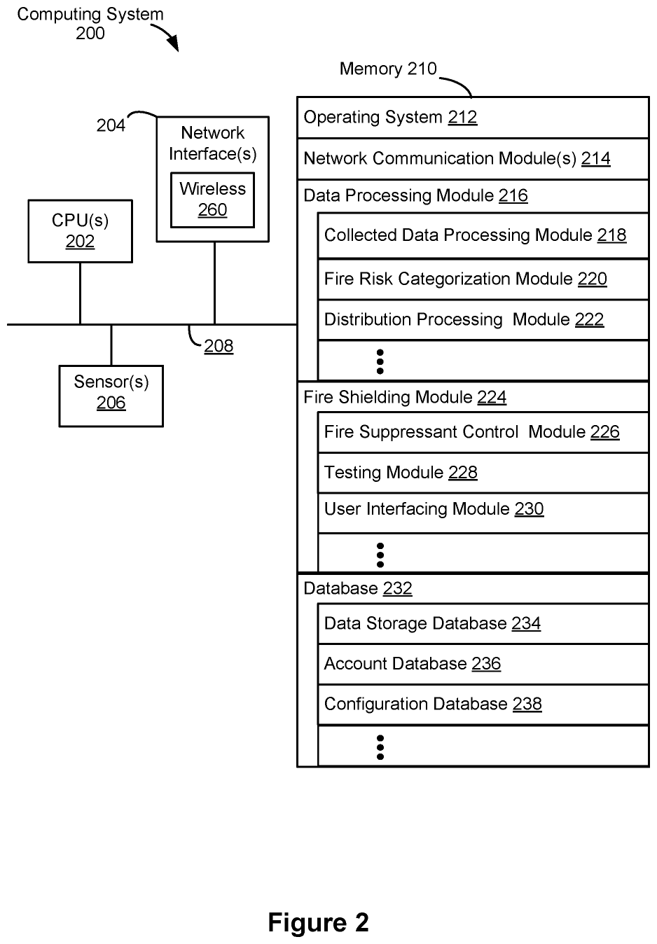

FIG. 2 is a block diagram illustrating a computing system of the wildfire shielding system 120 in accordance with some implementations. The controller 200 typically includes one or more processing units (CPUs) 202, one or more network interfaces 204 (e.g., including an I/O interface to one or more client devices and an I/O interface to one or more electronic devices), one or more sensors 206, memory 210, and one or more communication buses 208 for interconnecting these components (sometimes called a chipset).

In some implementations, the one or more network interfaces 204 include wireless and/or wired interfaces for receiving data from and/or transmitting data to other wildfire shielding systems 120, client devices 130, and/or other devices or systems. In some implementations, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, IoT, etc.). Furthermore, in some implementations, data communications are carried out using any of a variety of custom or standard wired protocols (e.g., USB, Firewire, Ethernet, etc.). For example, the one or more network interfaces 204 include a wireless interface 260 for enabling wireless data communications with other wildfire shielding systems 120, client devices 130 (e.g., laptops, phones, tablets, smartwatches, and/or other connected devices), and/or or other wireless devices (e.g., centralized fire emergency monitoring systems such as a fire agency and/or fire department). Furthermore, in some implementations, the wireless interface 260 (or a different communications interface of the one or more network interfaces 204) enables data communications with other WLAN-compatible devices (e.g., client device(s) 130, servers 140, etc.).

In some implementations, the controller 200 is communicatively coupled to one or more sensors 206 including, but not limited to, moisture and/or dampness sensors; temperature, thermal, and/or heat sensors; humidity sensors; water composition sensors (e.g., shininess sensors), wind and/or airspeed sensors; anemometer, pressure sensors; flow sensors; light, optical, and/or imaging sensor; smoke and/or gas sensors, and/or meters. In some implementations, the one or more sensors include accelerometers, gyroscopes, compasses, magnetometer, near field communication transceivers, barometers, proximity sensors, range finders, and/or other sensors/devices for sensing and measuring various environmental conditions.

The memory 210 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 210, optionally, includes one or more storage devices remotely located from one or more processing units 202. The memory 210, or alternatively the non-volatile memory within memory 210, includes a non-transitory computer readable storage medium. In some implementations, the memory 210, or the non-transitory computer readable storage medium of the memory 210, stores the following programs, modules, and data structures, or a subset or superset thereof:
an operating system 212 including procedures for handling various basic system services and for performing hardware dependent tasks;
a network communication module 214 for connecting the wildfire shielding system 120 to other systems and devices (e.g., client devices, electronic devices, and/or systems connected to one or more networks 150) via one or more network interfaces 204 (wired or wireless);
a data processing module 216 for processing (e.g., analyzing) data received from the one or more sensors 206, data received from other wildfire shielding systems 120, and/or data collected from the network 150 (e.g., safety reports, media coverage, satellite information, etc.). In some implementations, the data processing module 216 also includes the following modules (or sets of instructions), or a subset or superset thereof:
   a collected data processor module 218 for processing the data collected from one or more sensors 206, data collected from other wildfire shielding systems 120, and/or data collected from the network 150;
   a fire risk categorization module 220 for determining a risk categorization for the respective structure 110 based on the processed sensor data, data received from other wildfire shielding systems 120, and/or data collected from the network 150; and
   a distribution processing module 222 for determining one or more zones of a respective structure or structure 110 to distribute fire suppressant and/or adjust default parameters or configurations the wildfire shielding system to accommodate for actual conditions at the time and in ‘real-time’;
a fire shielding module 224 for operating (e.g., initiating, deactivating, testing, etc.) the wildfire shielding systems 120. In some implementations, the fire shielding module 224 also includes the following modules (or sets of instructions), or a subset or superset thereof:
   a fire suppressant control module 226 for providing one or more instructions that distribute and/or control the distribution of the fire suppressant to one or more zones of the respective structure 110;
   a testing module 228 for providing one or more instructions for testing the wildfire shielding systems 120, scheduling testing, and performing maintenance on the wildfire shielding systems 120; and
   a user interfacing module 230 for communicating (e.g., providing information, warnings, notifications, messages, and prompts for executable actions, as well as receiving one or more commands (e.g., activation via user input), or instructions from the user) with a user via associated client devices 130 of a respective wildfire shielding system 120; and
a database 232 for storing and accessing data including but not limited to:
   a data storage database 234 for storing and accessing data collected from one or more sensors 206, other wildfire shielding systems 120, and/or collected from the network (e.g., safety reports, media coverage, satellite information, etc.);
   an account database 236 for storing and accessing data corresponding to a respective user including user settings, preferences, structure information (e.g., size and location of the structure), and/or user responses (e.g., initiating, deactivating, testing, requesting data, etc.); and
   a configuration database 238 for storing and accessing data corresponding to maintenance schedules, one or more zones of a structure 110, the number of nozzles in a zone, the placement of the one or nozzles in the one or more zones, the number of sensor; the location of the sensors, automation (e.g., automatic activation; wetting durations according to shade, sun, or time of day; etc.), and/or other information corresponding to the installed configuration of the wildfire shielding system 120.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise rearranged in various implementations. In some implementations, the memory 210, optionally, stores a subset of the modules and data structures identified above. Furthermore, the memory 10, optionally, stores additional modules and data structures not described above.

In some implementations, the sever system 140 performs one or more of the functions described above with respect to FIG. 2. For example, the sever system 140 may include one or more of: a data processing module 216, a fire shielding module 224, and a database 232.

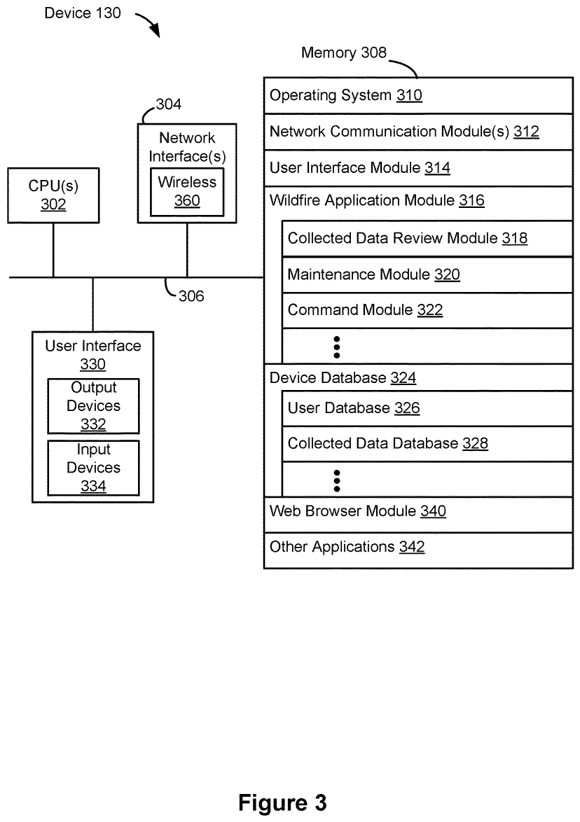

FIG. 3 is a block diagram illustrating a client device 130 (e.g., client device 130-1, 130-2 . . . 130-n, FIG. 1), in accordance with some implementations. The client device 130 includes one or more central processing units (CPU(s), i.e., processors or cores) 302, one or more network (or other communications) interfaces 304, memory 308, and one or more communication buses 306 for interconnecting these components. The communication buses 306 optionally include circuitry (sometimes called a chipset) that interconnects and controls communications between system components. In some implementations, the user interface 330 includes one or more output devices 332 that enable presentation of content, including one or more speakers and/or one or more visual displays. In some implementations, the user interface 330 also includes one or more input devices 334, including user interface components that facilitate user input such as a keyboard, a mouse, a voice-command input unit or microphone, a touch screen display, a touch-sensitive input pad, a gesture capturing camera, a video camera, and/or other input buttons or controls.

In some implementations, the one or more network interfaces 304 include wireless and/or wired interfaces for receiving data from and/or transmitting data to wildfire shielding systems 120, other client devices 130, and/or other devices or systems. In some implementations, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, IoT, etc.). Furthermore, in some implementations, data communications are carried out using any of a variety of custom or standard wired protocols (e.g., USB, Firewire, Ethernet, etc.). For example, the one or more network interfaces 304 include a wireless interface 360 for enabling wireless data communications with wildfire shielding systems 120, other client devices 130 (e.g., laptops, phones, tablets, smartwatches, and/or other connected devices), and/or or other wireless devices (e.g., centralized fire emergency monitoring systems such as a fire agency and/or fire department). Furthermore, in some implementations, the wireless interface 260 (or a different communications interface of the one or more network interfaces 204) enables data communications with other WLAN-compatible devices (e.g., client device(s) 130, servers 140, etc.).

The memory 308 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 308 may optionally include one or more storage devices remotely located from the CPU(s) 202. Memory 308, or alternately, the non-volatile memory solid-state storage devices within memory 308, includes a non-transitory computer-readable storage medium. In some implementations, memory 308 or the non-transitory computer-readable storage medium of memory 308 stores the following programs, modules, and data structures, or a subset or superset thereof:
an operating system 310 that includes procedures for handling various basic system services and for performing hardware-dependent tasks;
network communication module(s) 312 for connecting the client device 130 to the wildfire shielding systems 120, other client devices 130, and/or other devices via the one or more network interface(s) 304 (wired or wireless) connected to one or more network(s) 150;
a user interface module 314 that receives commands and/or inputs from a user via the user interface 330 (e.g., from the input devices 334) and provides outputs for display on the user interface 330 (e.g., the output devices 332);
a wildfire application module 316 (e.g., an application for accessing a wildfire shielding system 120 associated with the client device 130 for browsing, receiving, processing, presenting, testing, performing maintenance, and commanding the wildfire shielding system 120. The wildfire application module 316 is also used to monitor, store, and/or transmit (e.g., wildfire shielding system 120) data. The wildfire application module 316 may include the following modules (or sets of instructions), or a subset or superset thereof:
   a collected data review module 318 for accessing and reviewing data collected from the wildfire shielding systems 120 and/or data collected from the network 150 (e.g., safety reports, media coverage, satellite information, etc.), and reviewing risk determinations and risk categorizations;
   a maintenance module 320 for testing and performing maintenance tests on the wildfire shielding systems 120, and scheduling tests and maintenance for the wildfire shielding systems 120; and
   a command module 322 controlling (e.g., initiating, ceasing, scheduling, etc.) distribution of fire suppressant to one or more zones and/or one or more nozzles of the wildfire shielding systems 120;
a device database 324 for storing and accessing data including but not limited
   a user database 326 for storing and accessing data corresponding to a respective user including user settings, preferences, structure information, scheduled maintenance, scheduled testing, and/or user responses (e.g., initiating, deactivating, testing, requesting data, etc.); and
   a collected data database 328 for storing and accessing data collected from one or more sensors 206, other wildfire shielding systems 120, and/or collected from the network (e.g., safety reports, media coverage, satellite information, etc.); and
a web browser application 340 (e.g., Internet Explorer or Edge by Microsoft, Firefox by Mozilla, Safari by Apple, or Chrome by Google) for accessing, viewing, and interacting with web sites; and
other applications 342, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise rearranged in various implementations. In some implementations, the memory 308, optionally, stores a subset of the modules and data structures identified above. Furthermore, the memory 308, optionally, stores additional modules and data structures not described above.

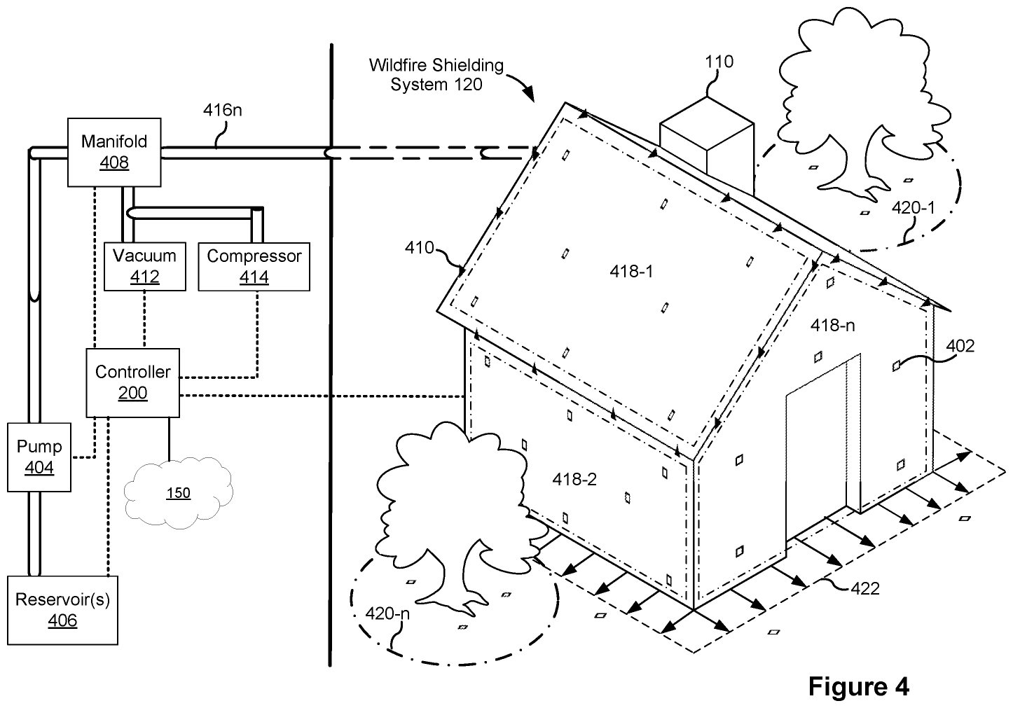

FIG. 4 illustrates a system for preventing the spread of fire in accordance with some implementations. In some implementations, wildfire shielding system 120 is part of a structure 110 (e.g., installed or retrofitted onto the structure 110). In some implementations, the wildfire shielding system 120 includes a controller 200, a plurality of sensors 402 (e.g., sensors described in FIG. 2), a pump 404, one or more reservoirs 406, a manifold 408, and a plurality of nozzles 410. In some implementations, the wildfire shielding system 415 includes a vacuum 412 and a compressor 414. Alternatively or additionally, in some implementations, the vacuum 412 and the compressor 414 can be a single device (e.g., a rotary vane pump). In some implementations, the reservoirs 406 are fluidically coupled to the pump 404, the pump 404 is fluidically coupled to the manifold 408, and the manifold 408 is fluidically coupled to the plurality of nozzles 410. In some implementations, the vacuum 412 and the compressor 414 are fluidically coupled to the manifold 408. In some implementations, one or more supply lines 416n are used to fluidically coupled the different components (e.g., pump 404 to manifold 408, manifold 408 to the plurality of nozzles 410, etc.)

The reservoirs 406 are configured to store a fire suppressant such as water, chemicals, gasses, and/or foams (generally referred to as “fire suppressant(s)”). The reservoirs 406 can be tanks, containers, pools, ponds, basins, and/or other receptacles for storing the fire suppressant. In some implementations, reservoirs 406 include a filter. In some implementations, the wildfire shielding system 120 includes two or more reservoirs 406 with at least one reservoir 406 holding a distinct fire suppressant. In some implementations, the type of fire suppressants distributed is based on the type of fire detected and/or the respective structure 110 (e.g., residential building versus industrial building). Alternatively or additionally, in some implementations, the at least two reservoirs include distinct fire suppressants that are combined (e.g., mixed) before distributed by the plurality of nozzles 410. In some implementations, each of the one or more reservoirs 406 includes the same fire suppressant. For example, each of the one or more reservoirs 406 may include water as the fire suppressant. In some implementations, the filter is a reverse osmosis filter, a de-ionization filter, an ultraviolet (UV) filter, infrared filter, carbon, and/or other type of filter. In this way, the fire suppressant is removed of impurities, debris, dirt, or other material that could damage components of the wildfire shielding system 120 and/or block the fire suppressant from being distributed (e.g., via the plurality of nozzles 410). In some implementations, the filtered fire suppressant is continuously is injected with Ozone (e.g., through a Venturi system).

In some implementations, the reservoirs 406 are on and/or adjacent to the structure 110. Additionally or alternatively, in some implementations, the reservoirs 406 are remotely located to the structure 110. For example, the reservoirs 406 may be located 10 ft., 50 ft., or 150 ft. away from the structure. In some implementations, the reservoirs 406 include one or more sensors of the plurality of sensors 402 for measuring the amount of fire suppressant and/or the type of fire suppressant in the reservoir 406. In some implementations, the amount of fire suppressant in the reservoir 406 is provided to the controller 200 (e.g., data for a fire suppressant level provided via a communicatively coupled sensors of the plurality of sensors 402). In some implementations, the data provided by the reservoirs 406 is used to keep the fire suppressant clean, sufficient levels (e.g., a quarter full, third full, etc.), and/or perform other maintenance operations. In some implementations, the reservoirs 406 are connected to a water supply system (e.g., a municipal water supply system, rivers, lakes, etc.) to ensure a good supply of water for use in wildfire shielding activities. Additionally or alternatively, in some implementations, the reservoirs 406 are configured to harvest a fire suppressant (e.g., collect rainwater).

In some implementations, the controller 200 of the wildfire shielding system 120 is coupled to one or more components of the wildfire shielding system 120 such as the plurality of sensors 402, pump 404, reservoirs 406, manifold 408, plurality of nozzles 410, vacuum 412, and/or the compressor 414. The controller 200 of the wildfire shielding system 120 can be directly and/or communicatively (e.g., via one or more networks 150) coupled to the one or more components of the wildfire shielding system 120. In some implementations, the controller 200 provides one or more instructions to respective components of the wildfire shielding system 120 to operate and/or maintain the wildfire shielding system 120. For example, a controller 200 coupled to a pump 404 is configured to provide one or more instructions to the pump 404 to start distribution, stop distribution, and/or otherwise control the distribution of the fire suppressant. The one or more instructions provided by controller 200 are discussed below.

In some implementations, the plurality of sensors 402 are coupled to the exterior of the structure 110. In some implementations, the plurality of sensors 402 face away from the exterior surface of the structure 110 (e.g., to collect data from conditions and events approaching the structure 110, such as wind). In some implementations, the plurality of sensors 402 are coupled to one or more components of the wildfire shielding system (e.g., the plurality of nozzles 410, the supply lines 416n, the manifold 408, etc.). In some implementations, the plurality of sensors 402 are coupled to and/or located within one or more zones 418 (e.g., zones 418-1, 418-2 . . . 418-n) of a respective structure 110. The one or more zones 418 include portions of the structure 110 such as one or more walls, the roof, and/or the underside of the roof. Any portion of the structure 110 can include more than one zone 418 (e.g., a wall can include two zones 418) and the one or more zones 418 can be the same or different sizes. In some implementations, a plurality of early warning and/or fire monitoring sensors 402 are remotely located from the structure 110 and placed in one or more remote zones 420 (e.g., remote zones 420-1 . . . 420-n). The one or more remote zones 420 include the surrounding area of the structure 110, such as the surrounding ground and/or foliage, plants, trees, forested areas, crops, and/or other locations some distance from the structure 110. In some implementations, a plurality of the sensors 402 are placed at one or more locations at risk of catching fire. For example, a plurality of the sensors 402 can be placed at locations impacted by drought or that have a consistently low water content/composition (e.g., humidity and/or dampness of less than 30 percent). The plurality of sensors 402 include the sensors 206 described in FIG. 2.

In some implementations, the plurality of sensors 402 are configured to collect data corresponding to the structure 110, zones 418, and/or remote zones 420 such as dampness, temperature, wind velocity, humidity, moisture, and/or a combination thereof. In some implementations, the plurality of sensors collect data corresponding to other environmental information such as air pollution, smoke, etc. The above identified metrics are a non-exhaustive list of the sensor data collected by the plurality of sensors 402, and other metrics for detecting a fire may be collected by the plurality of sensors 402. In some implementations, one or more of the plurality of sensors 402 detect the presence and/or the location of a fire. For example, the plurality of sensors 402 may include one or more image and/or optical sensors that detect the presence of fire and/or the general location of a fire. In some implementations, the plurality of sensors 402 collect data continuously, periodically, and/or at the occurrence of one or more triggering events. In some implementations, the one or more triggering events include controller 200 receiving information corresponding to other wildfire shielding systems 120 that have been initiated, receiving an indication of medium and/or high risk categorizations (described below) from other wildfire shielding systems 120, and/or high risk alerts and/or warnings from other sources via network 150 (e.g., fire warnings from agencies, such as fire departments; news and/or media alerts; satellite imaging, etc.). The plurality of sensors 402 are communicatively coupled to the controller 200 and provide the collected data to analyze and determine a risk category and/or to determine whether risk criteria are satisfied as described below. In some implementations, the plurality of sensors 402 are communicatively connected to the controller 200 through a wired and/or wireless connection as discussed above.

Alternatively or additionally, in some implementations, data is collected from a plurality of sensors 402 of other respective wildfire shielding systems 120 of other structures 110 and shared via network 150 (e.g., data collected from a plurality of sensors 402 of a first wildfire shielding system 120-1 can provide that data to a second wildfire shielding system 120-2). In some implementations, the wildfire shielding systems 120 share location data and/or structure information (e.g., size and/or type of structure). In some implementations, the wildfire shielding system 120 receives data from other sources connected to network 150, such as weather websites, news websites, media networks, satellite imaging data, emergency responders, and/or emergency agencies (e.g., fire departments). The data is provided to the controller 200 to analyze and determine a risk category and/or to determine whether risk criteria are satisfied as discussed below.

In some implementations, the controller 200 uses the data received by the plurality of sensors 402 (in the one or more zones 418 and/or remote zones 420) of a structure 110 to determine the presence of a fire and/or information corresponding to the detected fire (e.g., location, speed, size, etc.). In some implementations, the controller 200 uses dampness, temperature, wind velocity, humidity, and/or moisture to determine the location of a fire, the speed at which the fire is spreading (e.g., fire velocity), the direction that the fire is spreading, and/or the risk of fire on or near the structure. For example, the controller 200 may use the collected data to determine that wind at a first zone 418-1 has a higher temperature than wind at a second zone 418-2 of the structure 110 (e.g., difference of 5 degrees F. or more, or other differences determined in real-time or using look-up tables) and therefore a fire may be traveling towards the first zone 418-1 of the structure. Additionally or alternatively, in some implementations, the controller 200 uses the variations in the collected data over time to determine the location and/or direction of the fire. For example, the controller 200 can determine that increased temperature readings at the first zone 418-1 of the structure 110 (e.g., increase of 1 degree F. per minute, increase of 10 degree F. per half hour, etc.) indicate a fire in the direction of the first zone 418-1 of the structure 110. In some implementations, the controller 200 compares the data between zones (e.g., zones 418 and/or remote zones 420) to determine the presence of a fire and corresponding information. For instance, temperature differences between zones, dead or unresponsive zones, abnormal readings between zones (e.g., significant decrease in humidity, moisture, dampness, etc.), and/or other factors are used to determine the presence of a fire and corresponding information. Different combinations of data can be used to determine the presence and/or location of a fire.

Alternatively or additionally, the controller 200 uses the data received from other wildfire shielding systems 120 and/or other sources to determine the presence and information of a fire. For example, a high temperature measured at a first wildfire shielding system 120-1 compared to the temperature measured at a second wildfire shielding system 120-2 (e.g., difference of 5 degrees F. or more) can indicate that another wildfire shielding system 120 is near a fire or fighting a fire. In some implementations, the controller 200 receives information that other wildfire shielding systems 120 have been initiated and uses the information to determine the location of a fire. In some implementations, failure to collect data from other wildfire shielding systems 120 is used to determine the presence and location of a fire. For example, a determination that a first wildfire shielding system 120-1 has become unresponsive (e.g., stops providing data and/or fails to provide data) is used by the controller 200 to determine that the first wildfire shielding system 120-1 is fighting a fire or has been destroyed by a fire. In some implementations, a fire can be tracked based on a rate of death of wildfire shielding systems 120, sensors 402 (directly or externally coupled to a wildfire shielding systems 120), or other data sources and/or the location of the death. In other words, in some implementations a fires progression can be tracked based on the rate at which sensors 402 and or wildfire shielding systems 120 become unresponsive, and the location that they became unresponsive.

In some implementations, data from other sources (e.g., warning alerts, news reports, satellite imaging, etc.) is used to determine the presence of and/or information corresponding to a fire. For example, a controller 200 may receive from a fire department a warning indicator of a fire at a location and the controller 200 uses the data to determine the proximity of the fire to the structure 110 and information corresponding to the fire (e.g., size, speed, direction, etc.). In some implementations, the controller 200 uses the data received from other wildfire shielding systems 120 and/or other sources to supplement or add to the data received from the plurality of sensors 402. In this way, the controller 200 can detect the presence of a fire and/or other information corresponding to the fire in a number of different ways.

In some implementations, the controller 200 determines whether data received from the plurality of sensors 402 of the one or more zones 418 of the structure 110 satisfies risk criteria for the respective zones. Alternatively or additionally, in some implementations, the controller 200 determines whether additional data received from the plurality of sensors 402 in the one or more remote zones 420 of the structure 110, other wildfire shielding systems 120 of other structures 110, and/or other sources satisfy the risk criteria for the one or more zones 418 zones of the structure 110. For example, the controller 200 may use data received from the plurality of sensors 402 of the one or more zones 418 of a first structure 110 to determine whether the risk criteria are satisfied. Alternatively or additionally, the controller can use the data from the plurality of sensors 402 of the one or more zones 418 of the first structure 110 in conjunction with the data from the plurality of sensors 402 in the one or more remote zones 420, other wildfire shielding systems 120 of other structures 110, and/or other sources to determine whether the risk criteria are satisfied. In this way, the received data from the plurality of sensors for the one or more zones 418 can be updated by the additional data provided to the controller 200 and used to make accurate and informed determinations. In some implementations, the controller 200 determines for each zone of the one or more zones 418 whether the risk criteria are satisfied.

In some implementations, the risk criteria include a humidity threshold, dampness threshold, a fire or ember proximity threshold, a temperature threshold, and/or other environmental threshold (e.g., wind velocity, air pollution and/or air quality (e.g., carbon monoxide, nitrogen dioxide, formaldehyde, acetaldehyde, etc.)). In some implementation, the humidity threshold is satisfied when the humidity falls below 30 percent. In some implementation, the dampness threshold is satisfied when the dampness or moisture (e.g., water content) of foliage, plants, structure surfaces, debris, or other material falls below 30 percent. In some implementations, the fire proximity threshold is satisfied when a detected fire is at least a predetermined distance (e.g., 100 ft., 500 ft., 1 mile, etc.) away from a structure 110 (e.g., based on a determined location and distance of a fire as described above). In some implementations, the temperature threshold is satisfied when the temperature is greater than 90 degrees F. Alternatively or additionally, in some implementations, the environmental thresholds include wind velocities of at least 10 mph or greater and/or measured air pollutants greater than a predetermined amount (e.g., 20 micrograms per cubic meter). In some implementations, the risk criteria include a fire velocity threshold. The fire velocity threshold includes a fire moving at least 4 mph. In some implementations, the risk criteria include a predetermined number of wildfire shielding systems within a 5 mile radius of the structure 110 that have been initiated, a medium risk category or above, and have at least one respective risk criteria satisfied. The predetermined number of wildfire shielding systems could be one or more and may depend on the number of wildfire shielding systems in the network 150 and/or in a region proximate to the structure 110.

In some implementations, the risk criteria include a combination of one of more factors. For example, in some implementations, the risk criteria include a higher wind velocity threshold (e.g., 15 mph) and a respective humidity threshold for the higher wind velocity threshold (e.g., 25 percent). Other examples include wind velocity above a reduced threshold (e.g., 5 mph) in the presence of a detected fire; low measurement for both humidity and dampness (e.g., at or below 35 percent each), reduced temperature threshold (e.g., 80 degrees F.) combined with a reduced humidity threshold (e.g., 28 percent), higher temperature threshold (e.g., 100 degrees F.) combined with a wind velocity threshold (e.g., 5 mph), etc. Any number of factors can be combined and more than two factors can be used for a given risk criterion. The particular thresholds of the combined factors may depend on the situation and the environment in which the wildfire shielding system 120 is implemented.

Additionally or alternatively, in some implementations, the controller 200 determines one or more risk categories (e.g., high risk, medium risk, and low risk) for the respective structure 110 and/or for each zone of its one or more zones 418. In some implementations, a high risk category is determined based on high risk thresholds. In some implementations, the high risk thresholds include a humidity threshold of 25 percent, a dampness threshold of 25 percent, a fire proximity threshold of 75 feet away from a structure 110, the temperature threshold of 120 degrees F. In some implementations, a medium risk category is determined based on medium risk thresholds. In some implementations, the medium risk thresholds include a humidity threshold of 30 percent, a dampness threshold of 30 percent, a fire proximity threshold of 100 feet away from a structure 110, the temperature threshold of 90 degrees F. In some implementations, a low risk category is determined based on low risk thresholds. In some implementations, the low risk thresholds include a humidity threshold of 35 percent, a dampness threshold of 35 percent, a fire proximity threshold of 150 feet away from a structure 110, the temperature threshold of 70 degrees F. Different combinations of the threshold can be used to determine the risk category as discussed above for the risk criteria.

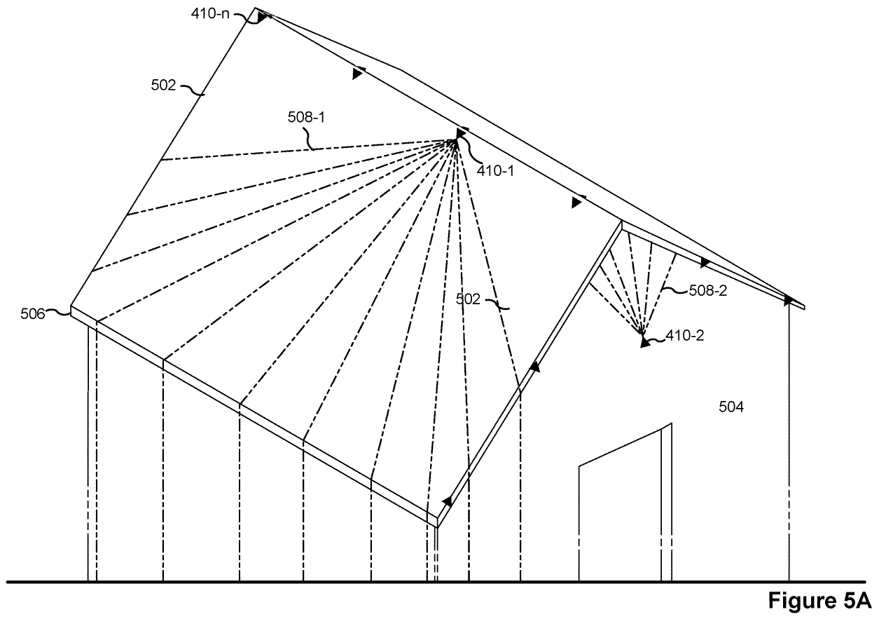

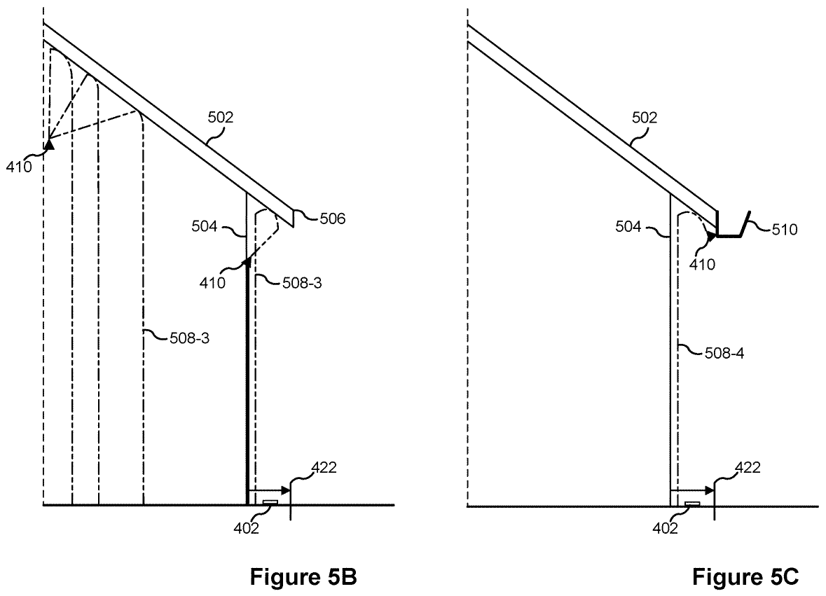

In some implementations, the plurality of nozzles 410 (e.g., nozzles 410-1, 410-2 . . . 410-n) are coupled to the structure 110 and/or coupled within the one or more zones 418 of the structure 110. Any number of nozzles may be placed on the structure 110 and/or within a respective zone of the one or more zones 418. Placement of the plurality of nozzles 410 on the structure 110 and/or in the one or more zones 418 is described below in FIGS. 5A through 5C. The plurality of nozzles 410 are configured to presoak the entire surface (e.g., roof, walls, overhangs, doorways, etc.) of the structure 110 as well as the surrounding ground (e.g., at least 3 feet from the structure 110). In some implementations, in accordance with a determination that the risk criteria are satisfied and/or at least a medium risk category, the wildfire shielding system 120, via one or more instructions provided by controller 200 (as described below), distributes the fire suppressant from the reservoir 406 to the plurality of nozzles 410. Distribution of the fire suppressant from the plurality of nozzles 410 is discussed below. In some implementations, each zone of the one or more zones 418 is associated with a set of nozzles from the plurality of nozzles. In some implementations, the wildfire shielding system 120, via controller 200, distributes the fire suppressant to the one or more zones that satisfy the risk criteria. For example, in accordance with a determination that the data satisfies the risk criteria for a first zone and not a second zone of the one or more zones 418, the wildfire shielding system 120, via controller 200, distributes the fire suppressant to a first set of nozzles of the plurality of nozzles 410 associated with the first zone and forgoes distributing fire suppressant to the second set of nozzles of the plurality of nozzles 410 associated with the second zone.

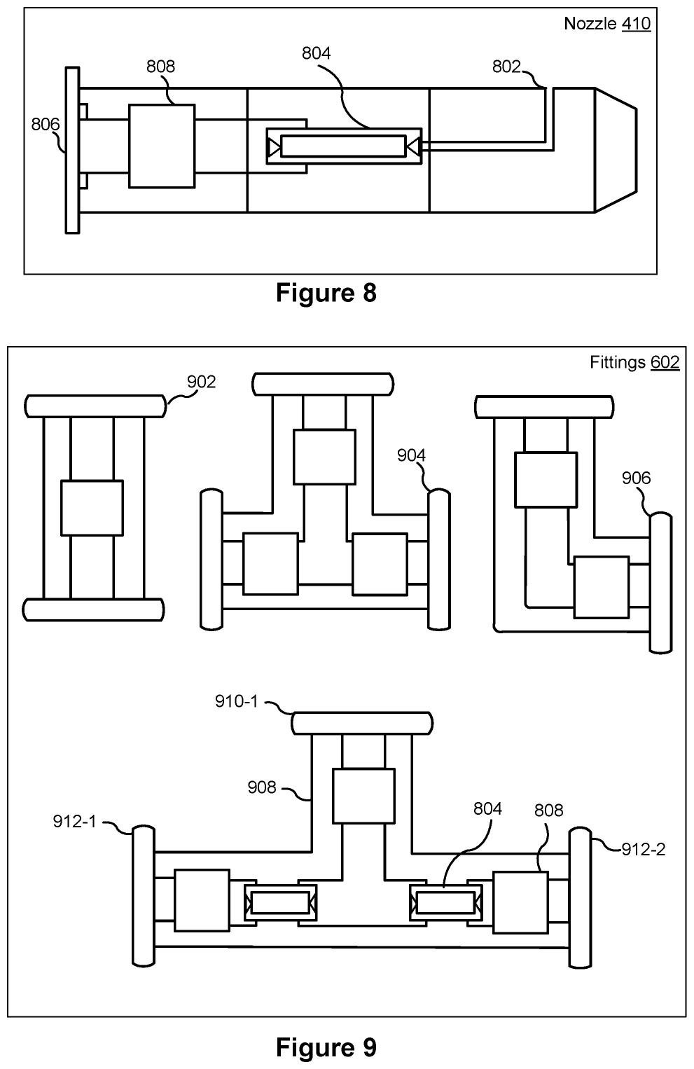

In some implementations, the fire suppressant is distributed from the plurality of nozzles 410 to presoak a structure 110. Presoaking a respective structure 110 stops an ongoing fire and/or prevents the spread of fire by putting out the fire and/or providing additional moisture to prevent the structure from catching on fire. In some implementations, the plurality of nozzles 410 presoak the structure 110 until the plurality of sensors 402 on the structure 110 or the ground proximate to the structure (e.g., at least 3 feet) measure a dampness and/or humidity of 30 percent or greater. A dampness and/or humidity of at least 30 percent reduce the chances of embers igniting portions of the structure 110. In some implementations, the fire suppressant is distributed from the plurality of nozzles 410 to presoak the structure 110 periodically such that the measured dampness and/or humidity remains at or above 30 percent. In some implementations, the plurality of nozzle are configured to presoak the respective structure 110 such that a threshold distance 422 from the outer walls of the respective structure 110 is presoaked by the fire suppressant. In some implementations, the threshold distance is at least 3 feet. The configuration of the nozzles of the plurality of nozzles 410 is discussed below in FIG. 8.

Distribution of the fire suppressant is controlled via the one or more instructions provided by the controller 200. In some implementations, the controller 200 is coupled to the pump 404 and configured to provide one or more instructions to initiate or cease operation of the pump 404. For example, the controller 200 can provide instructions to the pump 404 to distribute the fire suppressant from the reservoir 406 to the manifold 408. In some implementations, the instructions provided by the controller 200 to the pump 404 initiate the pump 404 for a predetermined period of time. For example, the controller 200 can provide instructions to the pump 404 that cause the pump 404 to operate for 5 min., 15 min, 25 min., 1 hr., and/or any other length of time defined by a user. In some implementations, the controller 200 provides instructions to the pump 404 that causes the pump 404 to operate until the amount of fire suppressant in the reservoirs 406 falls below a predetermined level. For example, the instructions provided to the pump 404, by the controller 200, can cause the pump to operate until the reservoir 406 is three quarters full, half full, fully depleted, and/or any other level defined by the user. In yet another example, the controller 200 can provide instructions to the pump 404 that cause the pump 404 to distribute the fire suppressant in predetermined pulses. For example, the controller 200 can instruct the pump 404 to distribute the fire suppressant for 1 min. on and 1 min. off intervals. In some implementations, the controller 200 provides the instructions to the pump 404 in accordance with the risk criteria being satisfied and/or a high or medium risk category as discussed above.

In some implementations, the controller 200 is coupled to the manifold 408 and provides one or more instructions to control distribution of the fire suppressant. As discussed above, in some implementations, the controller 200 determines one or more zones 418 of a structure 110 that satisfy the risk criteria and/or have a particular risk category (e.g., high and/or medium risk). In accordance with the one or more zones 418 of the structure 110 satisfy the risk criteria and/or have a particular risk category, the controller 200 provides instructions to the manifold 408 to distribute the fire suppressant at the respective zones satisfying the risk criteria and/or having a particular risk category. The instructions provided by the controller 200 to the manifold 408 can specify an amount of fire suppressant to be distributed in a particular zone (e.g., via respective nozzles), the rate at which the fire suppressant should be distributed to a respective zone, the frequency at which the fire suppressant should be distributed, and/or other distribution characteristics such that the dampness and/or humidity measured at the one or more zones (e.g., via the plurality of sensors 402) of the structure 110 and/or the ground proximate to the structure (e.g., 3 feet) is at least 30 percent. For example, the controller 200 may determine that the risk criteria are satisfied for a first zone of the one or more zones 418 and provide instructions to the manifold 408 to distribute the fire suppressant in the first zone of the one or more zones 418 such that the fire suppressant presoaks the first zone (e.g., achieving a water composition of at least 30 percent).

Alternatively or additionally, in some implementations, the instructions provided by the controller 200 to the manifold 408 are configured to manage the amount of fire suppressant distributed based on data received from the one or more reservoirs 406. For example, a reservoir 406 may half full and the controller 200 may provide instructions to the manifold 408 such that fire suppressant can be distributed a predetermined length of time (e.g., 5 min, 10 min, . . . 30 min) while ensuring that the structure 110 is secure. In some implementations, based on the amount of fire suppressant in the one or more reservoirs 406, the controller 200 provides instructions the manifold 408 that prioritize one or more zones 418 of the structure 110. In some implementations, the one or more zones 418 are prioritized based on respective risk criteria being satisfied and/or determined risk categories. For example, a reservoir 406 that is a quarter full may include enough fire suppressant for a single zone, and the controller 200 provides instructions to the manifold 408 to distribute the fire suppressant to the zone at greater risk of catching on fire (e.g., zone that satisfies more risk criteria than the others, zones with high risk categories as opposed to low risk categories, and/or a combination thereof). Alternatively or additionally, in some implementations, the controller 200 may determine that there is the structure 110 is on fire or at significant risk of fire (e.g., all zones satisfying the risk criteria, three fourths of the zones satisfying the risk criteria, fire located 10 ft. from the structure 110, etc.) and provide one or more instructions to the manifold 408 to distribute all of the fire suppressant at all of the zones 418 and/or selectively target the portions of the structure 110 at the highest risk (e.g., a zone with all risk criteria satisfied compared to other zones with half of the risk criteria satisfied). In some implementations, the controller 200 is configured to select a type of fire suppressant based on the data received from the one or more reservoirs 406 and other collected sensor 402 data.

In some implementations, the controller 200 is coupled to the vacuum 412 of the wildfire shielding system 120. In some implementations, the controller 200 provides one or more instructions to the vacuum 412 to draw a vacuum in the wildfire shielding system 120 that applies a predetermined pressure (e.g., draws a vacuum) to fluidically coupled components. In some implementations, the predetermine pressure is between 0.2 psi to 4 psi, inclusive. In some implementations, the predetermine pressure is less than 0.2 psi or some other minimum opening valve pressure for a one-way valve described below in reference to FIG. 8). The predetermined pressure is used to test the wildfire shielding system 120 for any potential failures (e.g., leaks, malfunctioning nozzles, broken supply lines, etc.). In some implementations, the controller 200 provides instructions that specify one or more components of the wildfire shielding system 120 to be pressurized and tested. For example, the instructions provided by the controller 200 can specify that the manifold 408, plurality of nozzles 410, and/or the supply lines 416n be pressurized and tested. Alternatively or additionally, in some implementations, the controller 200 provides instructions that specify one or more zones 418, one or more supply lines 416n, and/or one or more sets of nozzles of the plurality of nozzles 410 to be pressurized and tested. For instance the instructions provided by the controller 200 can specify that a first zone 418-1 (e.g., respective nozzles and supply lines 416n for the first zone 418-1) and not a second zone 418-2 be pressurized and tested. The data collected by the plurality of sensors 402 while the wildfire shielding system 120 is pressurized allows the controller 200 to detect the one or more faults and their respective location (e.g., differences between the applied/removed predetermined pressure and the measured pressure). For purposes of this disclosure, “pressurize” can be a negative or positive pressure applied by the vacuum 412 or the compressor 414 (described below), with the predetermined pressures provided by the vacuum 412 and compressor 414 being opposite one another (i.e., to cancel each other out).

In some implementations, the controller 200 provides instructions to the vacuum 412 periodically. For example, the controller 200 may provide instruction to the vacuum 412 three times a day, twice a day, once a day, and/or other user specified testing times. In some implementations, the controller 200 provides instructions to the vacuum 412 before distributing the fire suppressant from the reservoir 406 to the one or more zones 418 (via the plurality of nozzles 410). In this way, the wildfire shielding system 120 is tested for potential leaks and/or failures before the fire suppressant is distributed. Additionally or alternatively, in some implementations, the vacuum 412 is used to maintain and upkeep the wildfire shielding system 120. In some implementations, the controller 200 provides one or more instructions to the vacuum 412 to apply a predetermined flushing pressure (e.g., draw a vacuum) to fluidically coupled components. The predetermined flushing pressure is at least greater than the predetermine pressure of 0.2 psi to 4 psi. In some implementations, the predetermined flushing pressure is at least greater than minimum opening valve pressure for the one-way valve. In some implementations, the predetermined flushing pressure is used to remove dirt, debris, excess fluid, and/or other obstructions from the fluidically coupled components. In some implementations, the vacuum 412 is a standalone component. Alternatively or additionally, in some implementations, the vacuum 412 and the compressor 414 are a single component (e.g., a rotary vane pump).

In some implementations, the controller 200 is coupled to the compressor 414 of the wildfire shielding system 120. In some implementations, the controller 200 provides one or more instructions to the compressor 414 to remove pressure and/or close the plurality of nozzles in the wildfire shielding system 120. The compressor 414 is configure to remove at least 0.2 psi to 4 psi. In some implementations, the controller 200 provides the instructions to the controller after providing instructions to the vacuum 412 and/or testing the wildfire shielding system 120. For example, after the vacuum 412 applies the predetermined pressure to the fluidically coupled components, the controller provides instructions to the compressor 414 to remove the predetermined pressure. In this way, the wildfire shielding system 120 returns to an operational state after performing tests. Similarly, in some implementations, after distributing the fire suppressant in one or more zones 418, the controller provides instructions to the compressor 414 to return the plurality of nozzles 410 to a state before the wildfire shielding system 120 was initiated.

Although not shown in FIG. 4, in some implementations, the one or more components of the wildfire shielding system 120 are powered via the structure 110 (e.g., connecting to one or more outlets of the structure 110). Alternatively or additionally, in some implementations, wildfire shielding system 120 the one or more components of the wildfire shielding system 120 are provided an independent power source. The independent power sources include power generators, solar panels, batteries, and/or other sources. In some implementations, the one or more components of the wildfire shielding system 120 are configured to harvest radiation from one or more radio signals and convert the harvested ration into useable power.

FIGS. 5A-5C illustrate installation of the plurality of nozzles on a structure in accordance with some implementations. In some implementations, the structure 110 includes a roof 502 and one or more walls 504. In some implementations, the roof 502 includes a portion that extends beyond the one or more walls 504 of the structure 110 (also referred to as an overhang 506). FIG. 5A shows placement of the plurality of nozzles 410 (nozzles 410-1, 410-2 . . . 410-n) on the roof 502 and the distribution of the flows 508. For ease, a limited number of nozzles are shown, however, any number of nozzles may be installed on the structure 110 and/or within the zones 418 of the structure. In some implementations, the plurality of nozzles 410 are placed at the top of the roof 502 and configured to disperse fire suppressant across the area of roof 502. For example, nozzle 410-1 is shown in an initiated state and distributes the fire suppressant (e.g., flow 508-1) on and over the surface of roof 502. The plurality of nozzles are positioned such that the entire surface of the roof 502 is presoaked by the fire suppressant when initiated and/or extinguishes any fire on the structure 110. The fire suppressant that flows over the roof 502 (e.g., flow 508-1) is further configured to dampen and/or provide moisture to the surround ground of the structure 110 as discussed below. In some implementations, each nozzle of the plurality of nozzles 410 can be activated individually, by their respective zones 418, or all at once (e.g., via instructions from the controller 200).

Further shown in FIG. 5A, is placement of the plurality of nozzles 410 configured to disperse fire suppressant on the one or more walls 504 of the structure 110. For example, nozzle 410-2 is shown in an initiated state and distributes the fire suppressant (e.g., flow 508-2) on wall 504. The plurality of nozzles 410 are positioned such that the entire surface of the wall 504 is presoaked by the fire suppressant when initiated. The excess fire suppressant from flow 508-2 is further used to dampen and/or provide moisture to the surround ground of the structure 110 as discussed below. Alternatively or additionally, in some implementations, the plurality of nozzles 410 are placed on or near eaves of the structure 110. In some implementations, placement of the plurality of nozzles 410 is limited to (or near) the eaves of the structure 110.

FIGS. 5B and 5C illustrates placement of one or more nozzles on the structure 110 in accordance with some implementations. In some implementations, one or more nozzles of the plurality of nozzles 410 are placed on a wall 504 of the structure 110 with nozzle outlets (e.g., 806; FIG. 8) pointing under the roof 502 (e.g., bottom portion of the overhang 506). Alternatively or additionally, in some implementations, one or more nozzles of the plurality of nozzles 410 are placed on a wall 504 of the structure 110 with nozzle outlets (e.g., 806; FIG. 8) pointing directly upwards towards the wall 504 and under the roof 502. The one or more nozzles are placed such that the fire suppressant is distributed at the bottom portion of the overhang 506. The distributed fire suppressant presoaks the bottom portion of the overhang 506, flows (e.g., flow 508-3) back towards wall 504, presoaks the wall 504, and presoaks a predetermined distance from the wall 504. In some implementations, the predetermined distance 422 from the wall 504 that is presoaked is at least 3 ft. In some implementations, presoaking is determined by one or more sensors (e.g., of the plurality of sensors 402) detecting a water composition (e.g., dampness) of at least 30 percent.

Similarly, FIG. 5C shows structure 110 with a roof 502 that extends beyond one or more walls 504 of the structure 110. Structure 110 includes a gutter coupled to roof 502 (e.g., at an end portion of overhang 506). In some implementations, one or more nozzles of the plurality of nozzles 410 are placed through a portion of the gutter 510 with nozzle outlets (e.g., 806; FIG. 8) pointing directly at the bottom portion of the overhang 506. As described above, the one or more nozzles are placed such that the fire suppressant is distributed at the bottom portion of the overhang 506. The distributed fire suppressant presoaks the bottom portion of the overhang 1006, flows (e.g., flow 508-4) back towards wall 504, presoaks the wall 504, and presoaks a predetermined distance 422 from the wall 504 as described above in FIG. 5B.

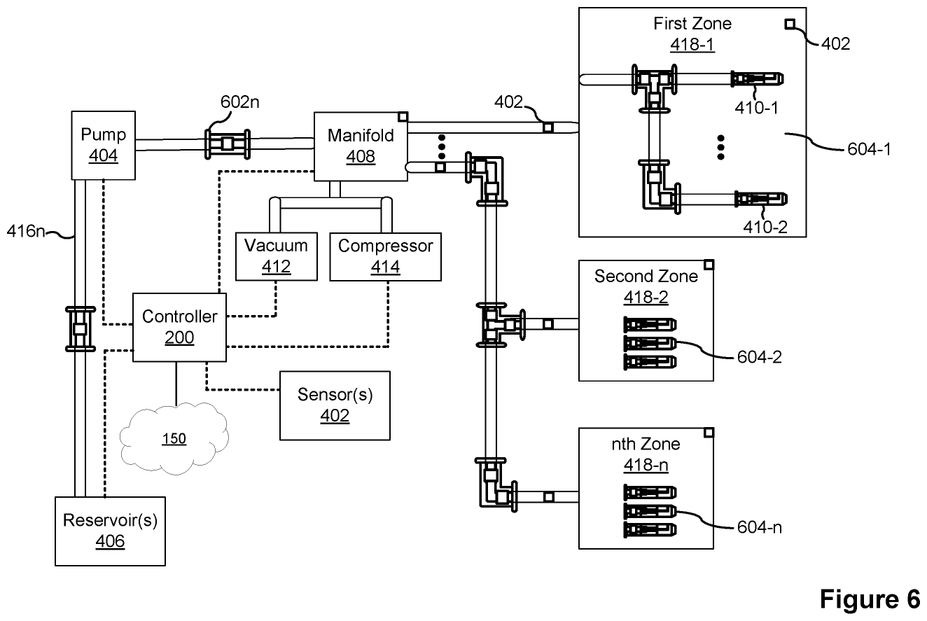

FIG. 6 illustrates the manifold of the wildfire shielding system in accordance with some implementations. As described above, in some implementations, the manifold 408 is fluidically coupled to a pump 404, one or more reservoirs 406, and a plurality of nozzles 410. In some implementations, the manifold 408 is fluidically coupled to a vacuum 412 and a compressor 414. In some implementations, the manifold 408 is fluidically coupled to the one or more components via one or more supply lines 416n. Additionally or alternatively, in some implementations, the one or more supply lines 416n are used in combination with one or more fittings 602n to fluidically couple the one or more components. Manifold 408 can have dedicated supply lines 416 to one or more zones 418 (e.g., first zone 418-1) and/or can share one or more supply lines between one or more zone (e.g., second zone 418-2 and nth zone 418-n). Similarly, nozzles 410 can have dedicated supply lines 416 and/or can share one or more supply lines 416 (e.g., fluidically coupled with one or more fitting 602). For instance, in the first zone 418-1 includes first nozzle 410-1 fluidically coupled to a second nozzle 410-2 via one or more fittings 602n. In some implementations, the manifold 408, the plurality of nozzles 410, the one or more supply lines 416n, and/or other components include sensors of the plurality of sensors 402. In some implementations, the manifold 408 is coupled to the controller 200 as described above in FIG. 4.

In some implementations, at least two manifolds are fluidically coupled to a pump 404, one or more reservoirs 406, and a plurality of nozzles 410. The at least two manifolds are coupled to the controller 200, and perform similar functions as those described above for a single manifold. In some implementations, each manifold of the at least two manifolds has dedicated supply lines 416 to one or more respective zones 418. For example, a first manifold may include dedicated supply lines 416 to a first zone 418-1, and a second manifold may include dedicated supply lines 416 to a second zone 418-2. In some implementations, the at least two manifolds may include a main manifold (e.g., manifold 408) and a first and second remote manifold (not shown). The main manifold can be configured to distribute fire suppressant to the first and/or second manifolds, which each are responsible for dedicated zones. For brevity, the descriptions below are provided for a single manifold configuration; however, the at least two manifolds may perform the same or similar operations.

In some implementations, the manifold 408 controls the distribution of the fire suppressant to one or more zones 418 (e.g., first zone 418-1, second zone 418-2 . . . nth zone 418-n) and/or a set of nozzles of the plurality of nozzles 410 (e.g., first set of nozzles 410-1, second set of nozzles 410-2 . . . nth set of nozzles 410-n). For example, the manifold 408 may selectively distribute the fire suppressant to the first zone 418-1 and the first set of nozzles 410-1, while forgoing to distribute the fire suppressant to other zones 418 and or sets of nozzles 410. In some implementations, the manifold 408 specifies an amount of fire suppressant to be distributed in a particular zone, the rate at which the fire suppressant should be distributed to a respective zone, the frequency at which the fire suppressant should be distributed, and/or other distribution characteristics such that the dampness and/or humidity measured at the one or more zones (e.g., via the plurality of sensors 402) of the structure 110 and/or the ground proximate to the structure (e.g., 3 feet) is at least 30 percent. In some implementations, the manifold 408 distributes all of the fire suppressant provided by reservoir 406 from pump 404.

In some implementations, the plurality sensors 402 coupled to the one or more components (e.g., manifold 408, plurality of nozzles 410, supply lines 416n, etc.), the one or more supply lines 416n, the one or more fittings 602n of the wildfire shielding system 120 are used to collect data on the status and/or condition of the wildfire shielding system 120. For instance, the plurality of sensors on the one or more components are used to collect data on flow measurement (e.g., flow rate), leaks, blockages, and/or other potential faults. In some implementations, the controller 200 uses the data to determine the status and/or condition of the wildfire shielding system 120. In some implementations, the controller identifies one or more faults in the wildfire shielding system 120 based on the data provided by the plurality of sensors 402. For example, a leak in in the wildfire shielding system 120 can be detected by the plurality of sensors 402 and the controller 200 can identify the location of the leak (e.g., the one or more zones 418) and/or the failing component (e.g., a nozzle of the plurality of nozzles 410). In some implementations, the controller 200 provides instructions to the manifold 408 to avoid distribution of the fire suppressant at the identified location of the failure. In some implementations, the controller 200 provides instructions to the manifold 408 to adjust distribution of the fire suppressant from one or more zones 418 mitigate for failure. For example, if a failure is detected at a first zone 418-1 adjacent to a functioning second zone 418-2, the controller 200 will increase the pressure and flow rate of the plurality of nozzles 410 in the second zone 418-2 to protect (e.g., presoak) the first zone 418-1.

In some implementations, data provided from the one or more reservoirs 406 is used to determine the flow rate, fill level, type of fire suppressant, and/or other metrics for managing the flow of the fire suppressant. In some implementations, the data provided from the one or more reservoirs 406 further includes fire suppressant conditions (e.g., conditioned fire suppressant, unfiltered or filtered suppressant, etc.).

In some implementations, the controller 200 provide a client device 130 associated with the wildfire shielding system 120 information corresponding to the detected fault. In some implementations, the information corresponding to the detected fault identifies the type of fault, the location of the fault (e.g., a particular supply line, a particular nozzle, and/or other component of the wildfire shielding system 120), and/or how the fault can be corrected. As discussed below, in some implementations, different components of the wildfire shielding system 120 can be interchanged and or replaced as need.

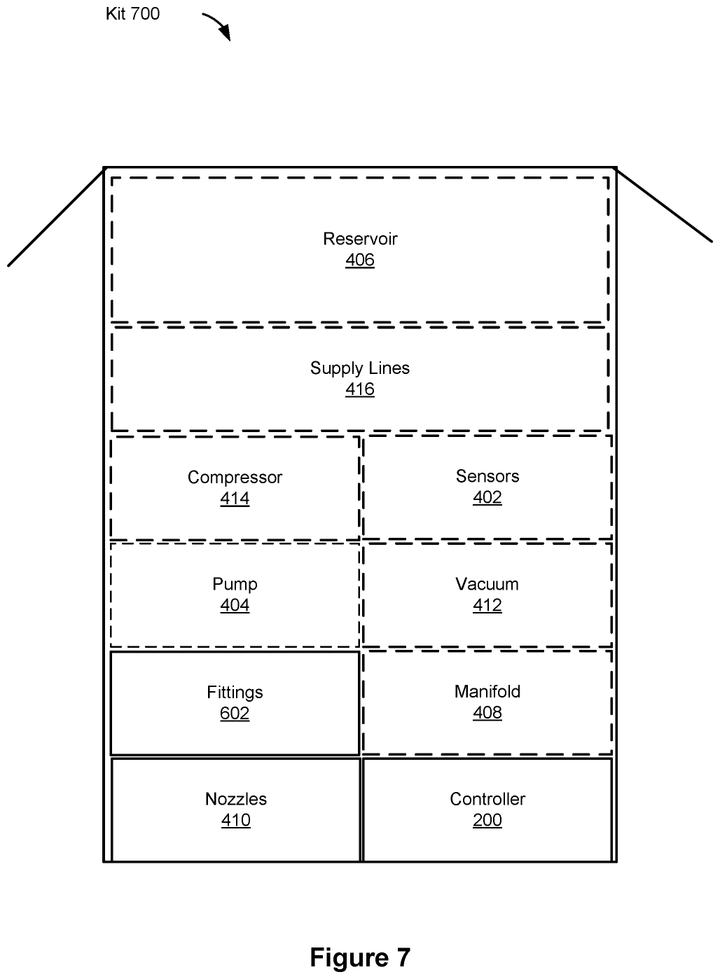

FIG. 7 illustrates a kit for installing and/or retrofitting a structure with the wildfire shielding system in accordance with some implementations. In some implementations, the kit 700 includes controller 200, plurality of nozzles 410, and one or more fittings 602n. The one or more components of the kit 700 can be positioned in any order. In some implementations, an owner of a structure 110 can provide measurements of the structure 110 that are used to determine the number of nozzles and the number of fittings to be included in the kit 700. The measurements include the total square footage (e.g., area) and/or acreage of the structure 110 (e.g., including measurements for structures and surrounding area), the number of floors of the structure 110, the size (e.g., length and/or width) of the roof, the roof configuration and/or add-ons (e.g., gutters, no gutters, roof jacks, solar panels, overhang distances, etc.), the size (e.g., length and/or width) of one or more walls, the number of exposed surfaces, etc. Alternatively or additionally, in some implementations, the owner of the structure 110 can provide one or more images of the structure 110 that are used to determine the number of nozzles and the number of fittings to be included in the kit 700. The images can be of different angles of the structure 110 (e.g., different walls, different perspectives, etc.) and/or an aerial or GPS satellite image of the top of the structure 110 including the surrounding terrain. The controller 200, the plurality of nozzles 410, and the one or more fittings 602n enable the owner to install and/or retrofit the wildfire shielding system 120 onto the structure 110. In some implementations, the owner of the structure 110 can connect the controller to a wired or wireless network 150. Additionally or alternatively, the owner can associate a client device 130 with the wildfire shielding system 120.

In some implementations, using the provided measurements and/or images of the structure 110, the kit provides instructions for identifying one or more zones 418 of the structure and a respective number of nozzles for the one or more zones 418. In some implementations, the kit includes instructions for identifying one or more remote zones 420 of the structure and a respective number of nozzles for the one or more remote zones 420. As described above, the one or more zones 418 are portions of the structure 110 such as the one or more walls, the roof, underside of the roof, etc., and the one or more remote zones 420 include the surrounding area of the structure 110 such as the surrounding ground and/or foliage, plants, forested areas, crops, and/or other locations a distance from the structure 110. In some implementations, the kit provides installing the plurality of nozzles 410 in different arrangements or positions on the structure 110. For example the instructions can include installing one or more nozzles on the roof, on the one or more walls, through the gutters, and/or under the gutters, facing the overhang, etc. The different positions and arrangements in which the plurality of nozzles may be installed and/or retrofitted are described above in FIGS. 4 through 5C.

In some implementations, the kit 700 includes a plurality of sensors 402. In some implementations, the number of sensors in the plurality of sensors 402 is determined using measurements and/or images of the structure 110 as described above. In some implementations, the owner of the structure 110 can install and/or retrofit the plurality of sensors 402 in one or more zones 418 of the structure 110. In some implementations, based on the measurements and/or images of the structure 110, the kit includes instructions for identifying a respective number sensors to be installed in the one or more zones 418 of the structure 110. Alternatively or additionally, in some implementations, based on the measurements and/or images of the structure 110, the kit includes instructions for identifying a respective number sensors to be installed in the one or more remote zones 420 of the structure 110. In some implementations, the kit 700 includes instructions for installing the plurality of sensors 402 on one or more components of the wildfire shielding system 120 (e.g., manifold 408, supply lines 416n, plurality of nozzles 410, etc.) The plurality of sensors 402 are configured to collect and provide data to the controller 200 for their respective installed location. The plurality of sensors 402 are installed and/or retrofitted as discussed above in FIG. 4.

In some implementations, the kit 700 includes the manifold 408 (or at least two manifolds). In some implementations, the size (e.g., number of connections) of the manifold 408 is determined based on the measurements and/or image of the structure 110, the number of nozzles provided in the kit 700, and/or the number of identified one or more zones 418 of the structure 110. In some implementations, the manifold 408 is configured to fluidically couple to each nozzle of the plurality of nozzles 410 and at least one reservoir of the one or more reservoirs 406. In some implementations, the manifold 408 included in the kit 700 is configured to fluidically couple (via one or more supply lines 416) to more nozzles than the number of nozzles provided in the kit 700. In this way, an owner is able to expand the wildfire shielding system 120 as needed or desired. In some implementations, the manifold 408 is associated with one or more zones 418 or remote zones 420 for the plurality of nozzles 410. For example, the manifold 408 can group a first subset of nozzles into a first zone and a second subset of nozzles into a second zone. In some implementations, the first and second subset of nozzles may share one or more zones. In some implementations, the manifold 408 can configure a predetermined number of zones. For example, the manifold 408 can be associated with 4, 8, 12, 16, etc. zones (i.e., set up to one or more zones and configured to distribute fluid to the one or more zones). As described above in reference to FIG. 6, the one or more functions can be performed by at least two manifolds (e.g., a main manifold and at least one remote manifold).

In some implementations, the manifold 408 is configured to couple to the controller 200, and receive one or more instructions as described above in FIG. 4.

In some implementations, the kit 700 includes one or more supply lines 416n. In some implementations, the number of supply lines 416n and their sizes (e.g., diameters and/or lengths) is determined based on the measurements and/or images of the structure 110 and/or the number of nozzles provided in the kit 700. Alternatively or additionally, in some implementations, the kit includes a predetermined number of supply lines 416n and sizes (e.g., diameters and/or lengths) based on the sizing of the structure. For example, a structure 110 of 1000 square feet or less will receive a first number of supply lines 416n, a structure 110 greater than 1000 square feet will receive a second number of supply lines 416n. In some implementations, the one or more supply lines 416n are configured to fluidically couple to the pump 404, the one or more reservoirs 406, the manifold 408, and each nozzle of the plurality of nozzles 410. In some implementations, the one or more supply lines 416n are configured to fluidically couple to the vacuum 412 and/or the compressor 414. For example, the one or more supply lines 416n may be used to fluidically couple the pump 404 to the manifold 408. In some implementations, the one or more supply lines 416n are to fluidically couple one or more components of the wildfire shielding system 120 using the one or more fittings 602n. For instance, the manifold 408 may be fluidically coupled to a first supply line of the one or more supply lines 416n that is fluidically couple to a first fitting of the one or more fittings 602n and the first fitting of the one or more fittings 602n is further coupled to a second supply line of the one or more supply lines 416n that is coupled to a first nozzle of the plurality of nozzles 410.

In some implementations, the one or more supply lines 416n are pipes (e.g., copper, aluminum, Cross-linked polyethylene (PEX), Polyvinyl Chloride (PVC), Chlorinated polyvinyl chloride (CPVC), High-density polyethylene (HDPE), etc.), hoses, tubes, and/or other types of connectors. In some implementations, the one or more supply lines 416n are configured to withstand freezing temperatures and or other harsh environments. The one or more supply lines 416n can be selected for different environmental conditions (e.g., freezing temperatures) and/or cost efficiency. In some implementations, the one or more supply lines 416n are configured to be easily replaced. For example, a broken supply line can be removed and replaced with another supply line using the one or more fittings (as described below in FIG. 9). Additionally or alternatively, the one or more supply lines 416n are configured to be easily installed and/or adjusted such that an owner can configure the wildfire shielding system 120 as desired.

In some implementations, the one or more supply lines 416n are the same and/or distinct lengths. In some implementations, the one or more supply lines 416n are the same and/or distinct outside diameters. In some implementations, the one or more supply lines 416n have an outside diameter of at least a quarter (¼) of an inch. In some implementations, the outside diameter of the supply lines is determined by one or more configurations of the structure 110. For example, a roof of a structure 110 may include a roof jack and including one or more nozzles on the roof require smaller outside diameters. The supply lines are configured to couple the one or more components of the wildfire shielding system 120 and are configured to adjust in diameter as needed. In some implementations, multiple supply lines are fluidically coupled together. In this way, the plurality of nozzles 410 can be easily installed in one or more zones 418 of the structure 110 without having to adjust the placement of the manifold 408 and/or other components. In some implementations, the one or more supply lines 416n are configured to be fluidically coupled and decoupled from the one or more fittings 602n as described below in FIG. 9.

In some implementations, the kit 700 includes the pump 404. In some implementations, the pump 404 is configured to be fluidically coupled between the one or more reservoirs 406 and at least the manifold 408. In some implementations, the pump 404 is configured to receive one or more instructions from the controller 200. The one or more instructions provided by the controller 200 to the pump are configured to initiate, cease, and/or control operation of the pump 404. The controller 200 instructions to the pump 404 are described above in reference to FIG. 4.

In some implementations, the kit 700 includes the vacuum 412. In some implementations, the vacuum 412 is configured to be fluidically coupled to at least the manifold 408. In some implementations, the vacuum 412 is fluidically coupled near or approximate to the one or more zones 418. In some implementations, the vacuum 412 is fluidically coupled between the manifold 408 and the pump 404. In some implementations, the vacuum 412 is fluidically coupled to one or more of the supply lines 416. In some implementations, the vacuum 412 is configured to receive one or more instructions from the controller 200 that are configured to initiate one or more tests and/or maintenance (e.g., detect any leaks and/or breaks in the system) on the wildfire shielding system 120 as described above in FIG. 4. In some implementations, the vacuum 412 is configured to operate as a compressor and provide a distinct predetermined pressure to clean and/or flush the wildfire shielding system 120 (additional information on compressors provided below. For example, in some implementations, the vacuum 412 may be a rotary vane pump that can be configured to provide the predetermined pressure as well as remove the predetermined pressure.

Alternatively or additionally, in some implementations, the kit 700 includes compressor 414. In some implementations, the compressor 414 is configured to be fluidically coupled at least the manifold 408. Alternatively, in some implementations, the compressor 414 is fluidically one or more locations of the wildfire shielding system 120 to efficiently and effectively remove fire suppressant from the system. For example, the compressor 414 can be fluidically at or near one or more zones 418, one or more nozzles of the plurality of nozzles 410, one or more reservoir 406, and/or that can readily release excess fire suppressant. In some implementations, the compressor 414 is configured to receive one or more instructions from the controller 200 that are configured to remove the predetermined pressure generated by the vacuum 412 as described above in FIG. 4. In some implementations, the compressor 414 is configured to return the wildfire shielding system 120 to a state before the wildfire shielding system 120 was initiated or testing and/or maintenance was performed. Additionally, in some implementations, the compressor 414 provides a predetermined pressure to clean and/or flush the wildfire shielding system 120.

The one or more tests and/or maintenance operations performed by the vacuum 412 and the compressor 414 reduce or prevent damage from accident breakage or leaks in the wildfire shielding system 120.

In some implementations, the kit 700 includes one or more reservoirs 406. In some implementations, the size and/or number of reservoirs 406 is determined based on the measurements and/or images of the structure 110. For instance, a respective structure 110 may be a single story residence that can be serviced by a single reservoir 406. Alternatively, the a respective structure 110 maybe an apartment complex and/or a multi-story residence that required multiple reservoirs 406 to shield the respective structure 110 from fires. In some implementations, the number of reservoirs 406 is based on one or more of the number of square feet, acres for a respective structure 110, surface (e.g., shape, material, size, etc.) to be protected, elevation, humidity levels, and/or other environmental factors. In some implementations, the one or more reservoirs 406 have a capacity of at least 5,000 gallons of fire suppressant for structures 110 of up 1,500 sq. ft. In some implementations, the one or more reservoirs 406 have a capacity of at least 10,000 gallons of water for structures 110 over 1,500 sq. ft. In some implementations, the kit 700 includes a filter for the reservoirs 406. Additional information about the one or more reservoirs 406 is provided above in FIG. 4.

FIG. 8 illustrates a nozzle of the plurality of nozzles in accordance with some implementations. In some implementations, nozzle 410 includes a nozzle inlet 802, a one-way valve 804 (e.g., a Schrader valve), and/or a nozzle orifice 806 (e.g., an outlet). In some implementations, the nozzle inlet 802 is configured to fluidically couple to the manifold 408. In some implementations, the nozzle inlet 802 is configured to fluidically couple to the manifold 408 via a supply line 416n.

In some implementations, the nozzle inlet 802 includes a push-to-connect connector 808 (also referred to as a sharkbite connector). The push-to-connect connector 808 is configured to fluidically couple with the manifold 408, supply lines 416n, and/or other connections. In some implementations, the push-to-connect connector 808 is configured to connect with supply lines 416n and/or other connections with an outside diameter of at least a quarter (¼) of an inch. In some implementations, the push-to-connect connector 808 configured to couple with supply lines 416n and/or other connections of different outside diameters (e.g., 0.75 inches, 1 inch, 1.25 inches, etc.). For example, the push-to-connect connector 808 may be configured to connect to with a supply line 416n that has an outside diameter of at least three quarters (¾) of an inch. The push-to-connect connector 808 of nozzle 410 allow for easy installation of the wildfire shielding system 120 on the structure 110. Additionally, the push-to-connect connector 808 of nozzle 410 allows for easy replacement and/or servicing of parts if a failure is detected at the nozzle 410 and/or the fluidically coupled supply lines 416n and/or other connections (e.g., removing the nozzle 410 from a faulty supply line 416n).

In some implementations, the nozzle orifice 806 is configured to distribute the fire suppressant in different spray patterns. In some implementations, the nozzle orifice 806 is configured as a cone nozzle, fan nozzle, hollow cone nozzle, tank cleaning nozzle, flood jet nozzles and/or other variations thereof. In some implementations, the nozzle orifice 806 is configured to distribute all of the fire suppressant provided by the manifold such that there is no static fire suppressant remaining in the nozzle 410. In some implementations, the nozzle 410 distributes the fire suppressant at a pressure of at least 40 psi. In some implementations, the nozzle 410 distributes the fire suppressant at a predetermined rate. In some implementation, the predetermined rate is at least 5, 10, 15, etc. gallons per minute.

In some implementations, a one-way valve 804 is coupled in between the nozzle orifice 806 and the nozzle inlet 802. In some implementations, the nozzle orifice 806 and the nozzle inlet are threaded such that the one-way valve 804 can be coupled in between. The ne-way valve 804 is used in conjunction with the manifold 408, vacuum 412, and/or compressor 414 to test and/or perform maintenance on the wildfire shielding system 120. In some implementations, testing of the wildfire shielding system 120 is performed by applying a predetermined pressure to the wildfire shielding system 120 and determining the presence of one or more leaks, blockages (e.g., dirt, debris, etc.), and/or other failures (e.g., determined using the data collected from the plurality of sensors 402 and controller 200). One-way valve 804 of the nozzle 410 is configured to open and/or close at a predetermined pressure such that the one or more leaks, blockages, and/or other failures can be detected. In some implementations, the predetermined pressure of the one-way valve 804 is between 0.02 psi to 4 psi.

As described above in FIG. 4, the controller 200 provides one or more instructions to the vacuum 412 and/or the compressor 414 to apply and/or remove pressure from the wildfire shielding system 120. The pressure applied and/or removed by the vacuum 412 and/or the compressor 414 are configured to open and/or close the one-way valve 804 such that the wildfire shielding system 120 may be properly tested. In some implementations, the vacuum 412 and/or the compressor 414 failing to open and/or close the one-way valve 804 is used to determine (e.g., by the controller 200) whether there is a failure in the wildfire shielding system 120. For instance, if it is determined that the predetermined pressure provided by the vacuum 412 and/or removed from the compressor 414 fail open and/or close the one-way valve 804, the controller 200 determines that there is a fault in the wildfire shielding system 120 determines that there is a fault. In some implementations, the controller determines the location of the fault (e.g., a particular zone 418, supply line 416n, and/or nozzle 410). In some implementations, a user is notified, via network 150, if the failure and specific information corresponding to the failure (e.g., type of failure and location).

FIG. 9 illustrates one or more fittings in accordance with some implementations. The one or more fittings 602n are configured to fluidically couple the one or more components of the wildfire shielding system 120 and/or the one or more supply lines 416n. For example, one or more fittings 602n may be used to fluidically couple the manifold 408 to one or more supply lines 416n that are fluidically coupled to a nozzle of the plurality of nozzles 410.

In some implementations, a fitting of the one or more fittings 602n is a one-to-one connector 902 configured to fluidically couple at least two components of the wildfire shielding system 120. For example, the manifold 408 may be fluidically coupled to a supply line 416n that is fluidically coupled to a one-to-one connector 902 that is fluidically coupled to another supply line fluidically coupled a nozzle of the plurality of nozzles 410. Alternatively or additionally, in some implementations, a fitting of the one or more fittings 602n is a one-to-many or many-to-one connector 904 configured to fluidically couple a component to many components of the wildfire shielding system 120 via supply lines 416n. For instance, the manifold 408 may be fluidically coupled to a supply line 416n that is fluidically coupled to a one-to-many connector 904 that is fluidically coupled to a set of supply line fluidically coupled a set of nozzles of the plurality of nozzles 410. In some implementations, a fitting of the one or more fittings 602n is an angled connector 906 configured to fluidically couple the components of the wildfire shielding system 120 and allow for directing the flow of fire suppressant to different locations. In some implementations, the one or more fittings 602 include one or more one-way valves 804. As a result, a nozzle of the plurality of nozzles 410 can service at least two zones 418 independently (e.g., distribute fire suppressant to one zone without distributing fire suppressant to other zones). For example, a modified angled fitting 908 includes at least two one-way valves 804 at each opposing end 912-1 and 912-2, and two distinct zones 418 can be coupled (e.g., via supply lines 418) to respective opposing ends 912-1 and 912-2. In addition, a nozzle 410 can be coupled to a first orifice 910 to distribute fire suppressant from each zone of the at least two zones independently.

In some implementations, the one or more fittings 602n include push-to-connect connectors (e.g., push-to-connect connector 808). The one or more fittings 602n are configured to allow for easy installation of the wildfire shielding system 120 and/or replacement of the one or more components of the wildfire shielding system 120. The use of push-to-connect connectors allows for a user to fluidically couple one or more supply lines 416n and/or components of the wildfire shielding system 120 without having to solder and/or weld different components. In some implementations, the one or more fittings 602n include O-rings to reduce and/or prevent leaks in the wildfire shielding system 120.

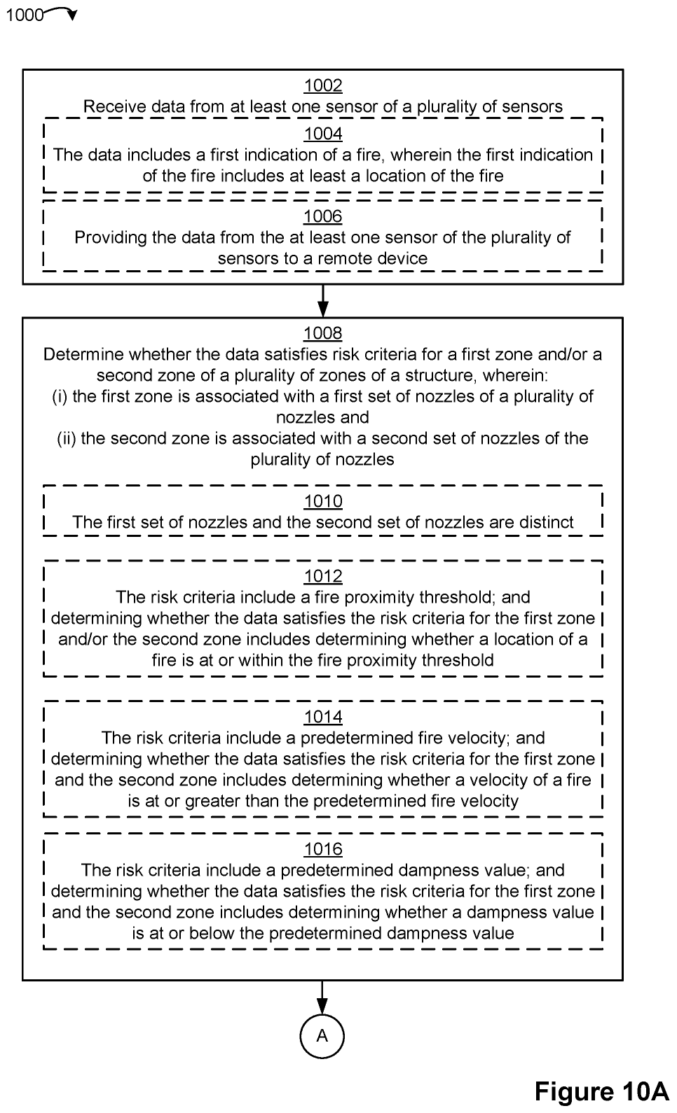

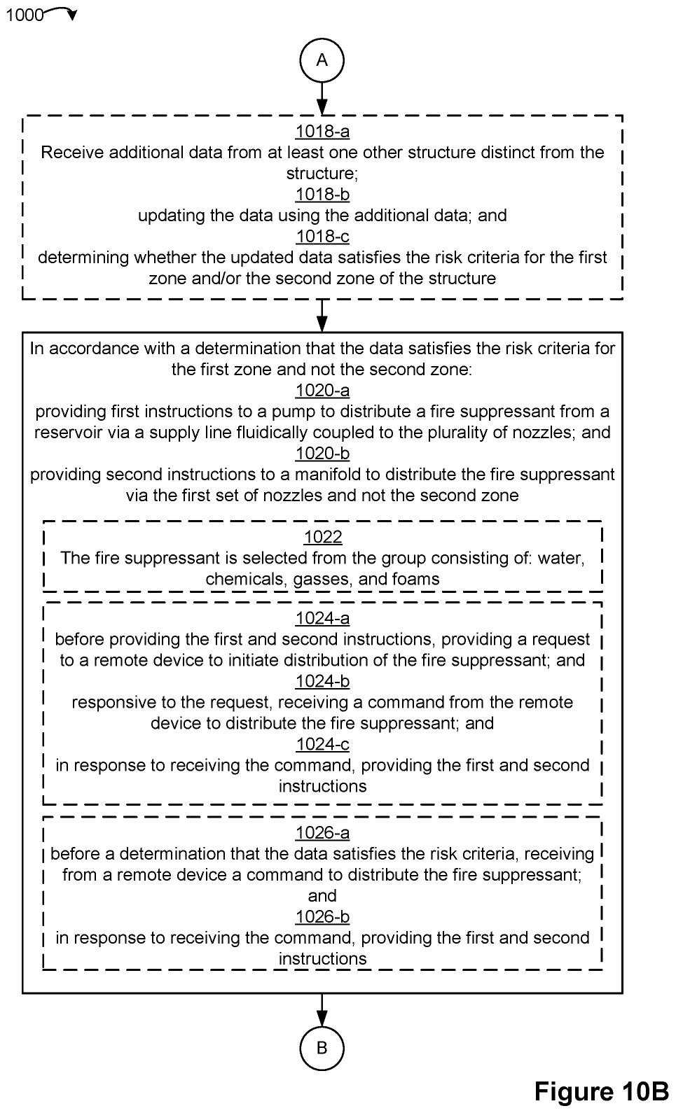

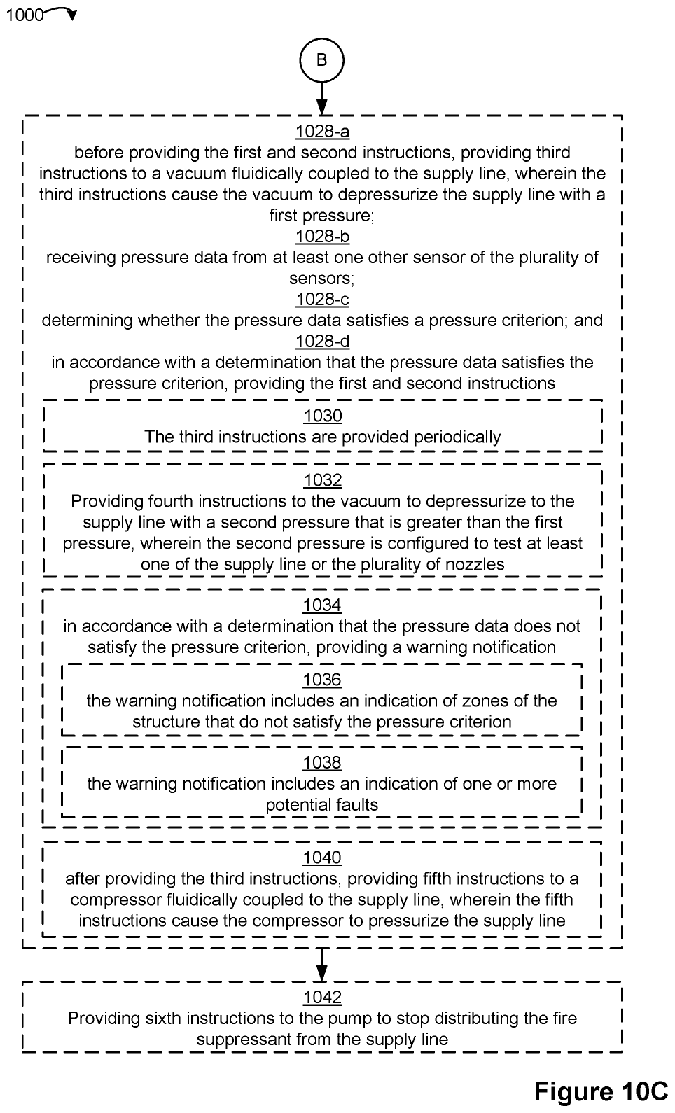

FIGS. 10A through 10C are flow diagrams illustrating methods of initiating the wildfire shielding system in accordance with some implementations. In some implementations, the methods are performed by: (1) a controller 200; (2) a client device 130; or (3) a combination thereof. In some instances and implementations, the various operations of the methods described herein are interchangeable, and respective operations of the methods are performed by any of the aforementioned devices, systems, or combination of devices and/or systems. For example, receiving data from at least one sensor of a plurality of sensors (1002) is optionally performed by controller 200 or a client device 130 associated with the wildfire shielding system 120. In some implementations, the methods are governed by instructions that are stored in one or more non-transitory computer-readable storage mediums, and that are executed by one or more processors, such as the CPU(s) 202 of the controller 200 and/or the CPU(s) 302 of a client device 130. For convenience, the method operations will be described below as being performed by particular component or device, but should not be construed as limiting the performance of the operation to the particular device in all implementations.

Method 1000 of initiating the wildfire shielding system 120 includes a controller 200 receiving (1002) data from at least one sensor of a plurality of sensors 402. In some implementations, the plurality of sensors 402 include moisture and/or dampness sensors; temperature, thermal, and/or heat sensors; humidity sensors; wind and/or airspeed sensors; pressure sensors; flow sensors; light, optical, and/or imaging sensor; smoke and/or gas sensors, and/or meters. In some implementations, the data includes (1004) a first indication of a fire. In some implementations, the first indication of the fire includes at least a location of the fire. In some implementations, the first indication of the fire may include a dampness content less than 30 percent (measured via a dampness and/or moisture sensor) in the foliage, soil, roof and/or one or more walls of the structure 110. In some implementations, the first indication of the fire may include not receiving data from one or more other wildfire shielding systems 120 connected to network 150 (e.g., dead sensors from structures 110 overcome by a fire. Additional examples of indications of a fire are provided above in FIG. 3. In some implementations, method 1000 includes providing (1006) the data from the at least one sensor of the plurality of sensors to a remote device (e.g., a client device 130). In some implementations, the data is provided to the remote device by the controller 200 and/or the plurality of sensors via network 150.

The controller 200, determines (1008) whether the data satisfies risk criteria for a first zone and/or a second zone of a plurality of zones of a structure (e.g., structure 110). The first zone is associated with a first set of nozzles of a plurality of nozzles 410 and the second zone is associated with a second set of nozzles of the plurality of nozzles 410. In some implementations, the first set of nozzles and the second set of nozzles are distinct (1010). In some implementations, the first set of nozzles and/or the second set of nozzles are less than all of the plurality of nozzles 410.

In some implementations, the risk criteria include (1012) a fire proximity threshold and determining whether the data satisfies the risk criteria for the first zone and/or the second zone includes the controller 200 determining whether a location of a fire is at or within the fire proximity threshold (e.g., 10 feet, 50 feet, 75 feet, 100 feet, 150 ft.). In some implementations, the risk criteria include (1014) a predetermined fire velocity and determining whether the data satisfies the risk criteria for the first zone and the second zone includes the controller 200 determining whether a velocity of a fire is at or greater than the predetermined fire velocity. In some implementations, the risk criteria include (1016) a predetermined dampness value and determining whether the data satisfies the risk criteria for the first zone and the second zone includes the controller 200 determining whether a dampness value is at or below the predetermined dampness value. The risk criteria are discussed above in FIG. 4.

In some implementations, the controller 200, receives (1018-a) additional data from at least one other structure distinct from the structure. The controller 200 updates (1018-b) the data using the additional data and determines (1018-c) whether the updated data satisfies the risk criteria for the first zone and/or the second zone of the structure. For example, the controller 200 may receive additional data from other wildfire shielding system 120 connected to network 150 and uses the additional data to determine whether the data satisfies the risk criteria. In some implementations, the additional data includes sensor data (temperature, dampness, humidity, etc.), risk criteria satisfied, risk categorization, status (e.g., initiated, ceased, faults), location, etc. Alternatively or additionally, in some implementations, the other wildfire shielding system 120 connected to network 150 failing to providing data is used as additional data. For example, if other wildfire shielding systems 120 have been overcome by fire and their respective sensors become unresponsive or fail, the unresponsive wildfire shielding systems 120 are used as additional data in determining whether the risk criteria are satisfied. In another example, communicatively coupled wildfire shielding systems 120 share data with each other and use the data to determine how to protect a structure 110. The wind direction, fire velocity, and all the other sensor data is used by the wildfire shielding system 120 to determine how to protect a structure 110.

In accordance with a determination that the data satisfies the risk criteria for the first zone and not the second zone: the controller 200 provides (1020-a) first instructions to a pump to distribute a fire suppressant from a reservoir via a supply line fluidically coupled to the plurality of nozzles and provides (1020-b) second instructions to the first zone and not the second zone to distribute the fire suppressant via the first set of nozzles. In some implementations, the fire suppressant is selected 1022 from the group consisting of: water, chemicals, gasses, and foams.

In some implementations, before providing the first and second instructions, the controller 200 provides (1024-a) a request to a remote device to initiate distribution of the fire suppressant. Responsive to the request, the controller 200 receives (1024-b) a command from the remote device to distribute the fire suppressant and, in response to receiving the command, the controller 200 provides the first and second instructions. The request is provided to the remote device (e.g., client device 130) such that the remote device can authorize, manage, and/or control the distribution of the fire suppressant as desired. In some implementations, the controller 200 will provide the first and second instructions without receiving a response the request if the risk category is high (e.g., structure 110 is facing a fire or at the brink of facing a fire). Alternatively or additionally, in some implementations, before controller 200 determines that the risk criteria are satisfied, the controller 200 receives (1026-a) from a remote device a command to distribute the fire suppressant and, in response to receiving the command, provides (1026-b) the first and second instructions. In this way, a user, owner, or agency (e.g., fire department) can control the distribution of the fire suppressant without having to wait for the risk criteria to be satisfied.

In some implementations, before the controller 200 provides (1028) the first and second instructions, the controller 200 provides (1028-a) third instructions to a vacuum fluidically coupled to the supply line. The third instructions cause the vacuum to depressurize the supply line with a first pressure. The controller 200 receives (1028-b) pressure data from at least one other sensor of the plurality of sensors and determines (1028-c) whether the pressure data satisfies a pressure criterion. In accordance with a determination that the pressure data satisfies the pressure criterion, the controller 200 provides (1028-d) the first and second instructions. As discussed above, applying pressure to the wildfire shielding system 120 allows for the supply lines 416n, the plurality of nozzles 410, and/or other components to be tested for leaks, blockages, and/or other faults. In particular, opening and closing the one-way valve 804 of nozzles 410 using the predetermined pressures (e.g., between 0.2-4 psi) allows controller 200 to determine the presence of faults in the wildfire shielding system 120. The pressure criterion is the expected pressure to be measured by the plurality of sensors 402 when the vacuum provides a predetermined pressure (e.g., between 0.2-4 psi). In some implementations, the third instructions are provided (1030) periodically.

In some implementations, the controller 200 provides (1032) fourth instructions to the vacuum to depressurize to the supply line with a second pressure that is greater than the first pressure. The second pressure is configured to test at least one of the supply line or the plurality of nozzles (e.g., determine if there are any leaks or breaks). In some implementations, after providing the third instructions, the controller 200 provides (1034) fifth instructions to a compressor fluidically coupled to the supply line. The fifth instructions cause the compressor to pressurize the supply line. In some implementations, in accordance with a determination that the pressure data does not satisfy the pressure criterion, the controller 200 provides (1036) a warning notification. In some implementations, the warning notification includes (1038) an indication of zones of the structure that do not satisfy the pressure criterion. In some implementations, the warning notification includes (1040) an indication of one or more potential faults. In some implementations, the warning notifications are provided to a user via network 150. In some implementations, the controller 200 provides (1042) sixth instructions to the pump to stop distributing the fire suppressant from the supply line.

All of these examples are non-limiting and any number of combinations and multi-layered structures are possible using the example structures described above.

Further implementations also include various subsets of the above implementations including implementations in FIGS. 1-10 combined or otherwise rearranged in various implementations, as one of skill in the art will readily appreciate while reading this disclosure.

Reference has been made in detail to implementations, examples of which have been illustrated in the accompanying drawings. In the above detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will also be understood that, although the terms “first,” “second,” etc. may be used herein to describe various elements, these elements should not be limited by these terms. These terms are only used to distinguish one element from another. For example, a first region could be termed a second region, and, similarly, a second region could be termed a first region, without changing the meaning of the description, so long as all occurrences of the “first region” are renamed consistently and all occurrences of the “second region” are renamed consistently. The first region and the second region are both regions, but they are not the same region.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for shielding against the spread of fire, the method comprising:
receiving data from at least one sensor of a plurality of sensors;
determining whether the data satisfies risk criteria for a first zone and/or a second zone of a plurality of zones of a structure, wherein: (i) the first zone is associated with a first set of nozzles of a plurality of nozzles and (ii) the second zone is associated with a second set of nozzles of the plurality of nozzles; and
in accordance with a determination that the data satisfies the risk criteria for the first zone and not the second zone:
providing first instructions to a pump to distribute a fire suppressant from a reservoir via a supply line fluidically coupled to the plurality of nozzles; and
providing second instructions to a manifold to distribute the fire suppressant via the first set of nozzles and not the second set of nozzles.

2. The method of claim 1, wherein the first set of nozzles and the second set of nozzles are distinct.

3. The method of claim 1, wherein the fire suppressant is selected from the group consisting of: water, chemicals, gasses, and foams.

4. The method of claim 1, further comprising:
before providing the first and second instructions, providing third instructions to a vacuum fluidically coupled to the supply line, wherein the third instructions cause the vacuum to depressurize the supply line with a first pressure;
receiving pressure data from at least one other sensor of the plurality of sensors;
determining whether the pressure data satisfies a pressure criterion; and
in accordance with a determination that the pressure data satisfies the pressure criterion, providing the first and second instructions.

5. The method of claim 4, wherein the third instructions are provided periodically.

6. The method of claim 4, further comprising, in accordance with a determination that the pressure data does not satisfy the pressure criterion, providing a warning notification.

7. The method of claim 6, wherein the warning notification includes at least one of an indication of zones of the structure that do not satisfy the pressure criterion, and an indication of one or more potential faults.

8. The method of claim 4, further comprising providing fourth instructions to the vacuum to depressurize to the supply line with a second pressure that is greater than the first pressure, wherein the second pressure is configured to test the supply line and/or the plurality of nozzles.

9. The method of claim 4, further comprising:
after providing the third instructions, providing fifth instructions to a compressor fluidically coupled to the supply line, wherein the fifth instructions cause the compressor to pressurize the supply line.

10. The method of claim 1, further comprising providing sixth instructions to the pump to stop distributing the fire suppressant from the supply line.

11. The method of claim 1, wherein:
the risk criteria include a fire proximity threshold; and
determining whether the data satisfies the risk criteria for the first zone and/or the second zone includes determining whether a location of a fire is at or within the fire proximity threshold.

12. The method of claim 1, wherein:
the risk criteria include a predetermined fire velocity; and
determining whether the data satisfies the risk criteria for the first zone and the second zone includes determining whether a velocity of a fire is at or greater than the predetermined fire velocity.

13. The method of claim 1, wherein:
the risk criteria include a predetermined dampness value; and
determining whether the data satisfies the risk criteria for the first zone and the second zone includes determining whether a dampness value is at or below the predetermined dampness value.

14. The method of claim 1, further comprising:
before a determination that the data satisfies the risk criteria, receiving from a remote device a command to distribute the fire suppressant; and
in response to receiving the command, providing the first and second instructions.

15. The method of claim 1, further comprising:
before providing the first and second instructions, providing a request to a remote device to initiate distribution of the fire suppressant; and
responsive to the request, receiving a command from the remote device to distribute the fire suppressant; and
in response to receiving the command, providing the first and second instructions.

16. The method of claim 1, further comprising providing the data from the at least one sensor of the plurality of sensors to a remote device.

17. The method of claim 1, wherein the data includes a first indication of a fire, wherein the first indication of the fire includes at least a location of the fire.

18. The method of claim 1, further comprising:
receiving additional data from at least one other structure distinct from the structure;
updating the data using the additional data; and
determining whether the updated data satisfies the risk criteria for the first zone and/or the second zone of the structure.

19. A wildfire shielding system of a structure, the wildfire shielding system comprising:
a plurality of nozzles coupled to one or more zones of a structure, wherein:
a first set of nozzles of the plurality of nozzles is coupled to and associated with a first zone of the one or more zones of the structure, and
a second set of nozzles of the plurality of nozzles is coupled to and associated with a second zone of the one or more zones of the structure,
a reservoir configured to store a fire suppressant;
a pump fluidically coupled to the reservoir and the plurality of nozzles via a supply line and a manifold;
a plurality of sensors coupled to at least one zone of the one or more zones;
one or more processors that are in communication with at least the plurality of sensors, the pump, and the manifold, the one or more processors configured to:
receive data from at least one sensor of the plurality of sensors;
determine whether the data satisfies risk criteria for the first zone and/or the second zone of the one or more zones of the structure;
in accordance with a determination that the data satisfies the risk criteria for the first zone and not the second zone of the one or more zones of the structure:
provide first instructions to the pump to distribute the fire suppressant from the reservoir via the supply line; and
provide second instructions to the manifold to distribute the fire suppressant via the first set of nozzles and not the second set of nozzles.

20. A non-transitory computer-readable storage medium storing one or more programs, the one or more programs comprising instructions, which when executed by a wildfire shielding system of a structure, cause the wildfire shielding system of a structure to:
receive data from at least one sensor of a plurality of sensors;
determine whether the data satisfies risk criteria for a first zone and/or a second zone of a plurality of zones of a structure, wherein: (i) the first zone is associated with a first set of nozzles of a plurality of nozzles and (ii) the second zone is associated with a second set of nozzles of the plurality of nozzles; and
in accordance with a determination that the data satisfies the risk criteria for the first zone and not the second zone:
provide first instructions to a pump to distribute a fire suppressant from a reservoir via a supply line fluidically coupled to the plurality of nozzles; and
provide second instructions to a manifold to distribute the fire suppressant via the first set of nozzles and not the second set of nozzles.
